(19) United States
(12) Patent Application Publication
(10) Pub. No.: US 2016/0335940 A1
(43) Pub. Date: Nov. 17, 2016

(54) METHOD FOR PROCESSING DISPLAY DATA AND ELECTRONIC DEVICE FOR SUPPORTING THE SAME

(71) Applicant: Samsung Electronics Co., Ltd., Gyeonggi-do (KR)

(72) Inventor: Myoung Soo You, Seoul (KR)

(21) Appl. No.: 15/152,229

(22) Filed: May 11, 2016

(30) Foreign Application Priority Data
May 11, 2015 (KR) 10-2015-0065394

(51) Int. Cl. G09G 3/20; G06F 3/041; G06F 3/14

(52) U.S. Cl. CPC G09G 3/2003; G06F 3/14; G06F 3/0416; G09G 2320/0666; G09G 2320/0626

(57) ABSTRACT

An electronic device includes a display, a memory configured to store display data output on the display, and a processor configured to operatively connect with the display and the memory. The processor is configured to change a display position of display data output on an active screen area if a screen output state change event for changing an output state of the active screen area of a or larger size occurs and to output the changed display data on the display.

### CROSS-REFERENCE TO RELATED APPLICATION AND CLAIM OF PRIORITY

The present application is related to and claims benefit under 35 U.S.C. §119(a) of a Korean patent application filed on May 11, 2015 in the Korean Intellectual Property Office and assigned Serial number 10-2015-0065394, the entire disclosure of which is hereby incorporated by reference.

### TECHNICAL FIELD

The present disclosure relates to methods for processing display data.

### BACKGROUND

If the same screen is displayed during a specific time or more on a display, such as an active matrix organic light emitting diode (AMOLED) display, which displays a screen by light emitting devices and the like, since the life of light emitting diodes included in a specific cell of a panel configuring the display is reduced, a burn-in phenomenon where image sticking occurs may occur. For example, an indicator bar which displays a communication state, a setting state, or event notification, and the like in an electronic device such as a smartphone may be displayed as the same icon or image and the like during a specific time or more. In this case, the burn-in phenomenon may occur on a boundary point between a region where the indicator bar is displayed and a region adjacent to the region where the indicator bar is displayed.

A conventional electronic device uses a method for changing a graphic user interface (GUI), for a method for adjusting a color or a method for changing a position of a specific object (e.g., an icon) to prevent the above-mentioned burn-in phenomenon. However, since an electronic device based on a software platform (or an operating system (OS)) may not change part of a GUI provided from a specific software platform, it may not apply the above-mentioned method.

### SUMMARY

To address the above-discussed deficiencies, it is a primary object to provide a method for changing a display position of display data output on a screen region of a specific or larger size upon occurrence of a specific event and an electronic device for supporting the same.

Accordingly, another aspect of the present disclosure is to provide a method for performing correction processing based on a change of a display position of display data and an electronic device for supporting the same.

Accordingly, another aspect of the present disclosure is to provide a method for changing display data output on a specified screen region if at least part of a screen is not changed during a specific time and an electronic device for supporting the same.

In accordance with an aspect of the present disclosure, an electronic device is provided. The electronic device may include a display, a memory configured to store display data output on the display, and a processor configured to operatively connect with the display and the memory. The processor may be configured to change a display position of display data output on a screen region if a screen output state change event for changing an output state of the screen region of a or larger size occurs and to output the changed display data on the display.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of an electronic device associated with processing display data based on an embodiment of the present disclosure;

FIG. 2 is a block diagram illustrating a configuration of an electronic device associated with processing display data based on an embodiment of the present disclosure;

FIG. 3 is a flowchart illustrating an electronic device operating method associated with processing display data upon receiving a screen output state change event based on an embodiment of the present disclosure;

FIG. 4 is a flowchart illustrating an electronic device operating method for processing display data based on a panel controller upon receiving a screen output state change event based on an embodiment of the present disclosure;

FIG. 5A is a drawing illustrating an LCD turn-on/off event among screen output state change events based on an embodiment of the present disclosure;

FIG. 5B is a drawing illustrating a screen rotation event among screen output state change events based on an embodiment of the present disclosure;

FIG. 5C is a drawing illustrating a screen shift event among screen output state change events based on an embodiment of the present disclosure;

FIG. 6 is a drawing illustrating a method for processing a display blank region among correction processing methods based on a change of a display position of display data based on an embodiment of the present disclosure;

FIG. 7 is a drawing illustrating a method for deleting a region matched with a display blank region among correction processing methods based on a change of a display position of display data based on an embodiment of the present disclosure;

FIG. 8 is a drawing illustrating a method using a display buffer which is larger than display data in size based on an embodiment of the present disclosure;

FIG. 9 is a drawing illustrating a method for scaling and displaying display data based on an embodiment of the present disclosure;

FIG. 10 is a drawing illustrating a screen for changing a display position of display data in response to occurrence of a screen output state change event based on an embodiment of the present disclosure;

FIG. 11 is a drawing illustrating a screen associated with a screen output state change event based on an embodiment of the present disclosure;

FIG. 12 is a drawing illustrating a screen associated with setting a size of a display panel based on an embodiment of the present disclosure;

FIG. 13 is a block diagram illustrating a configuration of an electronic device associated with changing display data based on an embodiment of the present disclosure;

FIG. 14 is a screen illustrating a method for changing display data applied for each region based on an embodiment of the present disclosure;

FIG. 15A is a drawing illustrating a color adjustment method among methods for changing display data based on an embodiment of the present disclosure;

FIG. 15B is a screen illustrating a result of applying a color adjustment method based on an embodiment of the present disclosure;

FIG. 16A is a drawing illustrating a blurring method among methods for changing display data based on an embodiment of the present disclosure;

FIG. 16B is a screen illustrating a result of applying a blurring method based on an embodiment of the present disclosure;

FIG. 17 is a drawing illustrating a luminance adjustment method among methods for changing display data based on an embodiment of the present disclosure;

FIG. 18 is a screen illustrating a process of merging regions to which a method for changing display data is applied based on an embodiment of the present disclosure;

FIG. 19 is a drawing illustrating a module associated with changing display data based on an embodiment of the present disclosure;

FIG. 20 is a flowchart illustrating an electronic device operating method associated with changing display data based on an embodiment of the present disclosure;

FIG. 21 is a flowchart illustrating an electronic device operating method associated with monitoring a display buffer based on an embodiment of the present disclosure;

FIG. 22 is a drawing illustrating a screen associated with changing display data based on an embodiment of the present disclosure;

FIG. 23 is a block diagram illustrating a configuration of an electronic device in a network environment based on an embodiment of the present disclosure

FIG. 24 is a block diagram illustrating a configuration of an electronic device based on an embodiment of the present disclosure; and

FIG. 25 is a block diagram illustrating a configuration of a program module based on an embodiment of the present disclosure.

Throughout the drawings, it should be noted that like reference numbers are used to depict the same or similar elements, features, and structures.

### DETAILED DESCRIPTION

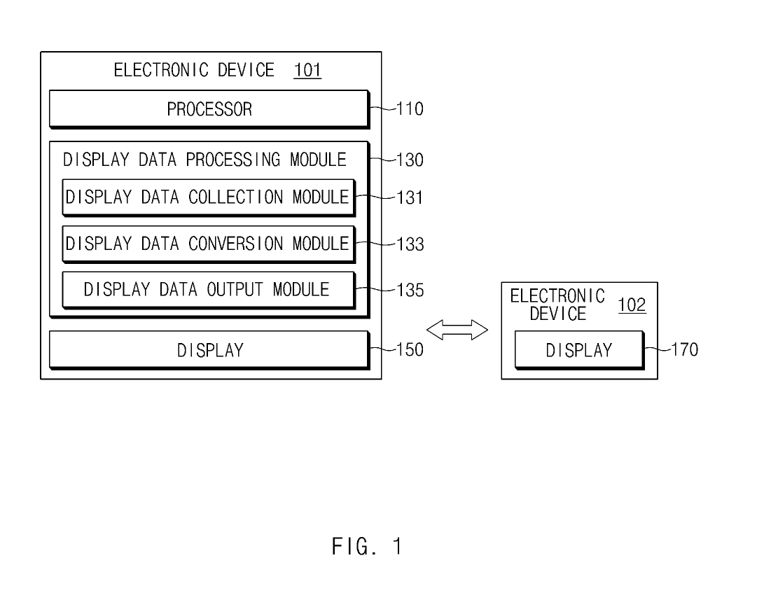

FIGS. 1 through 25, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, the present disclosure is described with reference to the accompanying drawings. However, the present disclosure is not intended to be limited to the specific embodiments, and it is understood that it should include all modifications and/or, equivalents and substitutes within the scope and technical range of the present disclosure. With respect to the descriptions of the drawings, like reference numerals refer to like elements.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The expressions such as “1st”, “2nd”, “first”, or “second”, and the like used in various embodiments of the present disclosure may refer to various elements irrespective of the order and/or priority of the corresponding elements, but do not limit the corresponding elements. The expressions may be used to distinguish one element from another element. For instance, both “a first user device” and “a second user device” indicate different user devices from each other irrespective of the order and/or priority of the corresponding elements. For example, a first component may be referred to as a second component and vice versa without departing from the scope of the present disclosure.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

Depending on the situation, the expression “configured to” used herein may be used as, for example, the expression “suitable for”, “having the capacity to”, “designed to”, “adapted to”, “made to”, or “capable of”. The term “configured to” must not mean only “specifically designed to” hardwarily. Instead, the expression “a device configured to” may mean that the device is “capable of” operating together with another device or other components. For example, a “processor configured to perform A, B, and C” may mean a generic-purpose processor (e.g., a central processing unit (CPU) or an application processor) which may perform corresponding operations by executing one or more software programs which stores a dedicated processor (e.g., an embedded processor) for performing a corresponding operation.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

Electronic devices according to various embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to an embodiment of the present disclosure, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

In various embodiments of the present disclosure, the electronic devices may be smart home appliances. The smart home appliances may include at least one of, for example, televisions (TVs), digital versatile disk (DVD) players, audios, refrigerators, air conditioners, cleaners, ovens, microwave ovens, washing machines, air cleaners, set-top boxes, home automation control panels, security control panels, TV boxes (e.g., Samsung HomeSync , Apple TV®, or Google TV®), game consoles (e.g., Xbox® and PlayStation®), electronic dictionaries, electronic keys, camcorders, or electronic picture frames.

In various embodiments of the present disclosure, the electronic devices may include at least one of various medical devices (e.g., various portable medical measurement devices (e.g., blood glucose meters, heart rate meters, blood pressure meters, or thermometers, and the like), a magnetic resonance angiography (MRA), a magnetic resonance imaging (MRI), a computed tomography (CT), scanners, or ultrasonic devices, and the like), navigation devices, global navigation satellite system (GNSS), event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to various embodiments of the present disclosure, the electronic devices may include at least one of parts of furniture or buildings/structures, electronic boards, electronic signature receiving devices, projectors, or various measuring instruments (e.g., water meters, electricity meters, gas meters, or wave meters, and the like). The electronic devices according to various embodiments of the present disclosure may be one or more combinations of the above-mentioned devices. The electronic devices according to various embodiments of the present disclosure may be flexible electronic devices. Also, electronic devices according to various embodiments of the present disclosure are not limited to the above-mentioned devices, and may include new electronic devices according to technology development

Hereinafter, electronic devices according to various embodiments of the present disclosure will be described with reference to the accompanying drawings. The term “user” used herein may refer to a person who uses an electronic device or may refer to a device (e.g., an artificial electronic device) that uses an electronic device.

FIG. 1 is a block diagram illustrating a configuration of an electronic device 101 associated with processing display data based on an embodiment of the present disclosure.

Referring to FIG. 1, the electronic device 101 according to various embodiments of the present disclosure may include a processor 110, a display data processing module 130, and a display 150. The electronic device 101 having these components may output display data, provided from an application program or a platform (or an operating system (OS)) installed in the electronic device 101, to a user. Also, the electronic device 101 may change a display position of display data output on a screen area (or region) of a specific or larger size to prevent a burn-in phenomenon which may be generated because the same display data is output during a specific time or more on a specified area. Alternatively, the electronic device 101 may prevent a burn-in phenomenon by changing display data output on a screen area which is not changed during a specific time or more.

To perform the above-mentioned functions, the processor 110 may process an event associated with display data. The processor 110 may include one or more of a central processing unit (CPU), an application processor (AP), or a communication processor (CP). The processor 110 may perform calculation or data processing about control and/or communication of at least another of components included in the electronic device 101. According to an embodiment of the present disclosure, the processor 110 may process an event associated with an operation of collecting, storing, converting, or outputting display data output on a screen of the electronic device 101. For example, if a screen change or output event occurs by an application program or a platform (or an OS), the processor 110 may store related display data in a storing medium included in the electronic device 101, for example, a memory or a graphic memory, and the like. According to an embodiment of the present disclosure, the processor 110 may generate a display buffer having a specific size in the storing medium and may store display data in the display buffer. Also, the processor 110 may control the display data processing module 130 to output stored display data.

According to various embodiments of the present disclosure, if the user may not recognize a screen change easily, for example, if an output state of a screen area of a specific or larger size is changed, the processor 110 may control the display data processing module 130 to change a display position of display data and output the changed display data as a method for preventing a burn-in phenomenon. In this regard, the processor 110 may control the display data processing module 130 to perform a function of collecting, changing, or outputting display data in response to an event (hereinafter referred to as a “screen output state change event”) generated if the output state of the screen area of the specific or larger size is changed. Also, if a specified area of a screen is not changed during a specific time, the processor 110 may send a display data output state change event to the display data processing module 130 to change display data output on the specified area of the screen to prevent the burn-in phenomenon.

If an event associated with display data occurs, the display data processing module 130 may perform a function of collecting, converting, or outputting display data output on a screen of the display 150. According to various embodiments of the present disclosure, the display data processing module 130 may include a display data collection module 131, a display data conversion module 133, and a display data output module 135.

The display data collection module 131 may collect display data output on a screen of the display 150. According to an embodiment of the present disclosure, the application program or the OS installed in the electronic device 101 may provide an interface for providing information to the user through a screen output or collecting information from him or her. In this case, the display data collection module 131 may collect display data to be output on a screen of the display 150 from the storing medium. In this regard, the display data may include display size information of frames configuring a screen, display position information of the frames, or information (e.g., a red, green, blue (RGB) value, a display position, and the like) of pixels configuring each of the frames, and the like.

The display data conversion module 133 may convert the collected display data. According to an embodiment of the present disclosure, the display data conversion module 133 may convert display data in response to a screen change or conversion and the like. For example, the display data conversion module 133 may convert display data in response to LCD turn on/off, screen rotation, or screen conversion, and the like.

According to various embodiments of the present disclosure, if a screen output state of a specified range or more is changed, for example, if LCD turn on/off, screen rotation, or screen conversion occurs (e.g., if new display data is displayed on a screen area of a specific or larger size), the display data conversion module 133 may change a display position of display data. For example, the display data conversion module 133 may change display positions of frames configuring a screen of the display 150. Also, the display data conversion module 133 may change display positions of pixels included in each of the frames.

In connection with changing a display position, the display data conversion module 133 may generate a coordinate value (e.g., an x-axis coordinate value or/and a y-axis coordinate value) corresponding to a changed position (or a moved position). According to an embodiment of the present disclosure, the display data conversion module 133 may generate the coordinate value based on at least one of a specific value, a size of a pixel, density of a pixel, screen resolution, or position relationship between the user and the electronic device 101. For example, the display data conversion module 133 may generate the coordinate value based on an experimental value for a degree to which the user may not recognize a screen change easily. For example, a manufacturer of the electronic device 101 may change a size of each of pixels configuring a screen, density of the pixels, screen resolution, or a viewing angle and distance of the user relative to the screen, and the like and may test a degree to which the user may recognizes screen shift.

According to various embodiments of the present disclosure, the display data conversion module 133 may determine a screen shift length of a degree to which the user may not recognize screen shift. According to an embodiment of the present disclosure, when a pixel is smaller in size, when a pixel is higher in density, when screen resolution is higher, when a viewing angle on a screen is wider, or when a viewing distance from the screen is longer, an amount of pixel movement on the screen may be relatively larger. Also, the display data conversion module 133 may designate the coordinate value as a specific coordinate value included in a range of the screen shift length or may randomly generate the coordinate value to be included in the range of the screen shift length. According to an embodiment of the present disclosure, the display data conversion module 133 may generate the coordinate value at a specific rate (e.g., less than 1%) to screen resolution. In this regard, the display data conversion module 133 may analyze a sensing value obtained from a sensor module and the like included in the electronic device 101 and may determine position relationship between the electronic device 101 and the user, for example, a viewing angle or distance of the user with respect to a screen of the display 150.

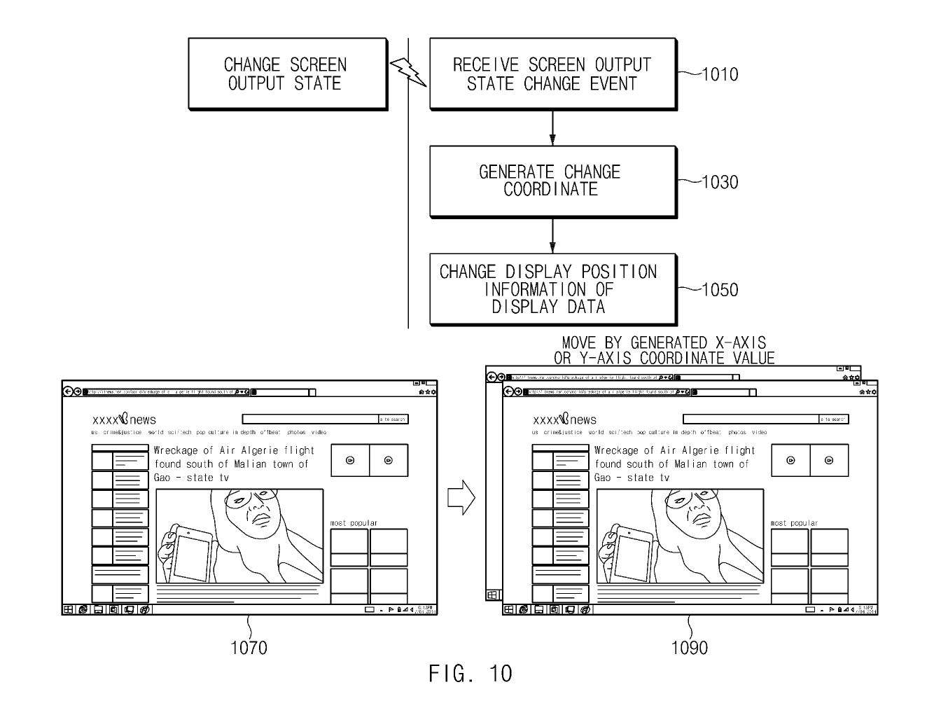

According to various embodiments of the present disclosure, as shown in FIG. 10, if an output state of a screen area of a specific or larger size is changed, for example, if an LCD is turned on or if a screen rotates, the display data conversion module 133 may change a display position of display data. For example, if receiving the screen output state change event, the display data conversion module 133 may generate a coordinate value corresponding to a changed position (or a moved position) and may change a display position of display data based on the generated coordinate value.

According to various embodiments of the present disclosure, in connection with changing the display position of the display data, the display data conversion module 133 may correct the changed display data such that the user may not recognize a screen change. For example, since there is no display data to be displayed based on screen shift in connection with changing a display position of display data, there may be a phenomenon where a blank is generated in a specific screen area or a phenomenon where display data is cut because of departing from the entire screen area. The display data conversion module 133 may correct the phenomenon.

Since a size of a display buffer which stores display data is limited, the above-mentioned phenomenon may occur. For example, if display data moves to correspond to a screen display point in a display buffer of a specific size, due to the movement, a portion where there is no display data in the display buffer and a portion where the display data is cut because of departing from a size range of the display buffer may be generated. According to an embodiment of the present disclosure, the display data conversion module 133 may change display position information included in display data rather than moving the display data stored in the display buffer in response to screen shift. Also, the display data output module 135 may output display data on a screen of the display 150 to correspond to a specific screen size based on display position information included in the display data. In this case, a specified area of a screen may not be displayed because there is no corresponding display data. Also, display data having display position information which is not included in a screen area of a specific size (e.g., the entire screen area) may not be output. To correct the above-mentioned phenomenon, the display data conversion module 133 may perform a function of correcting a display blank due to a screen change or a function of preventing a phenomenon where display data is cut by a screen change.

The function of correcting the display blank may be performed by a method of designating pixels included in a display blank area generated by a screen change by copying information of pixels located immediately before the screen change and copying information of pixels of an area (or region) adjacent to the display blank area. According to an embodiment of the present disclosure, the display data conversion module 133 may use a method of processing corresponding pixels to be identical to a display blank area and maintaining the symmetry of a screen as a method of deleting information of pixels included in the display blank area and information of pixels of a symmetrical position on a screen display position or a method of controlling not to output the corresponding pixels.

The function of preventing the phenomenon where the display data is cut may be performed by a method of scaling and storing display data stored in the display buffer. For example, the display data conversion module 133 may adjust a display size of display data to be proportionally smaller and may store the adjusted display data to prevent a phenomenon where display data to be displayed is cut in a process of displaying the display data. In this regard, a description will be given of a function of correcting display data based on various embodiments of the present disclosure.

According to various embodiments of the present disclosure, in connection with changing a display position, the processor 110 may correct a touch coordinate of an input device included in the electronic device 101, for example, a touch coordinate of a touch panel. According to an embodiment of the present disclosure, the processor 110 may change a coordinate value, recognized through a user input by the touch panel, based on the coordinate value. For example, the processor 110 may receive a value of an x-axis+3 pixel and a value of a y-axis+2 pixel as a shift coordinate value based on screen shift from the display data processing module 130. In this case, the processor 110 may calculate the shift coordinate value with a touch coordinate, for example, may add an x-axis+3 of a shift coordinate to a value corresponding to an x-axis of the touch coordinate and may add a y-axis+2 of the shift coordinate to a value corresponding to a y-axis of the touch coordinate to correct the touch coordinate. In this regard, the touch panel may include a control circuit which may perform a function of recognizing or changing a touch coordinate.

According to various embodiments of the present disclosure, the display data conversion module 133 may change display data. The display data conversion module 133 may change color information (e.g., an RGB value) of display data. For example, the display data conversion module 133 may reduce R, G, and B values of display data at a specific rate to be the same as each other. Also, the display data conversion module 133 may blur display data. For example, the display data conversion module 133 may blur display data, corresponding to a specified area of a screen, using an RGB average value of the display data. Also, the display data conversion module 133 may change luminance information of display data.

The display data output module 135 may output the collected or changed display data on the display 150. According to an embodiment of the present disclosure, the display data output module 135 may convert display data into an image signal and may output the converted image signal on the display 150. For example, the display data output module 135 may send display data or an image signal converted based on the display data to a device (hereinafter referred to as a “panel controller”) which drives corresponding elements of a panel which constitutes the display 150 based on pixel information of frames included in the display data. In this regard, the panel controller may be a device which processes the display data or the image signal converted based on the display data and outputs the processed data or signal on the display 150.

The display 150 may perform a function of outputting display data. For example, the display 150 may display a variety of data (e.g., text, an image, a video, an icon, or a symbol, and the like) to the user. According to an embodiment of the present disclosure, the display 150 may include a display panel which includes elements which may express a color (e.g., chrominance, brightness, and a chroma) based on an image signal.

According to various embodiments of the present disclosure, at least one of the components of the electronic device 101 may be omitted from the electronic device 101 or another component may be additionally included in the electronic device 101. Also, the electronic device 101 may control a screen output of a display 170 included in an external electronic device 102 connected with the electronic device 101 through wired and wireless communication. For example, if an output state of a screen area of a specific or larger size is changed on the display 170, the electronic device 101 may change a display position of related display data and may output the display data based on the changed display position on the display 170. Also, if a specified screen area is not changed during a specific time on the display 170, the electronic device 101 may change display data output on the screen area and may output the changed display data on the display 170. In this case, the electronic device 101 may collect the display data from a storing medium included in the external electronic device 102. Also, the electronic device 101 may send the display data or a related event to a panel controller included in the external electronic device 102. In various embodiments of the present disclosure, the electronic device 101 may output display data on the display 170 of the external electronic device 102 through a screen mirroring function. In this case, the electronic device 101 may output display data, which is output or will be output on the display 150, on the display 170 of the external electronic device 102.

According to various embodiments of the present disclosure, the electronic device 101 may include a touch panel which may receive a user input (e.g., a touch, gesture, proximity, or hovering). Also, the electronic device 101 may include a control circuit or a controller (hereinafter referred to as a “touch controller”) which may perform a function of recognizing or changing a touch coordinate of the touch panel. According to an embodiment of the present disclosure, the touch controller may be configured in the form of being included in the touch panel. Also, the display panel and the touch panel may be configured to constitute one module.

According to various embodiments of the present disclosure, as described above, the electronic device 101 may correct a touch coordinate of the touch panel included in the external electronic device 102 in connection with a function of controlling a screen output of the display 170 included in the external electronic device 102. In this case, the electronic device 101 may control a touch controller included in the external electronic device 102 to correct a touch coordinate.

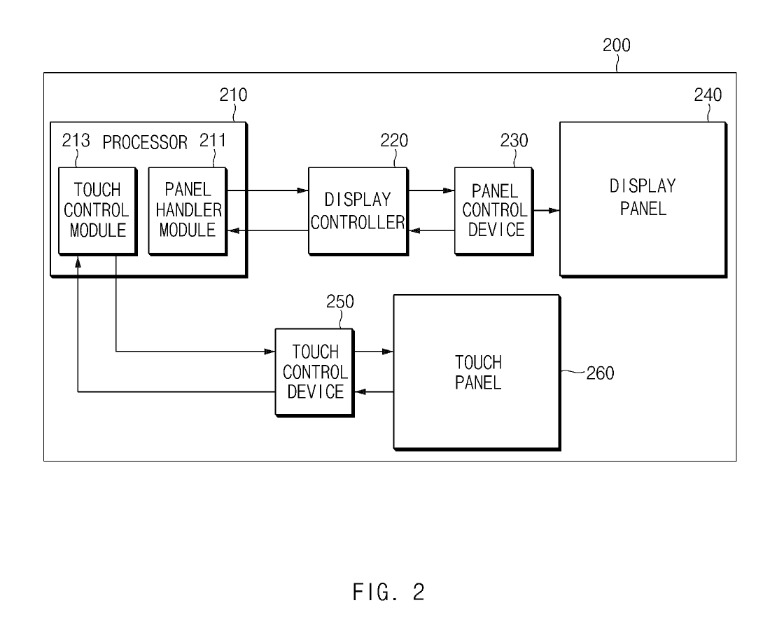

FIG. 2 is a block diagram illustrating a configuration of an electronic device 200 associated with processing display data based on an embodiment of the present disclosure. The same contents as the above-mentioned contents, contents similar to the above-mentioned contents, or contents corresponding to the above-mentioned contents may be omitted below.

Referring to FIG. 2, the electronic device 200 according to various embodiments of the present disclosure may include a processor 210, a display controller 220, a panel controller 230, a display panel 240, a touch controller 250, and a touch panel 260.

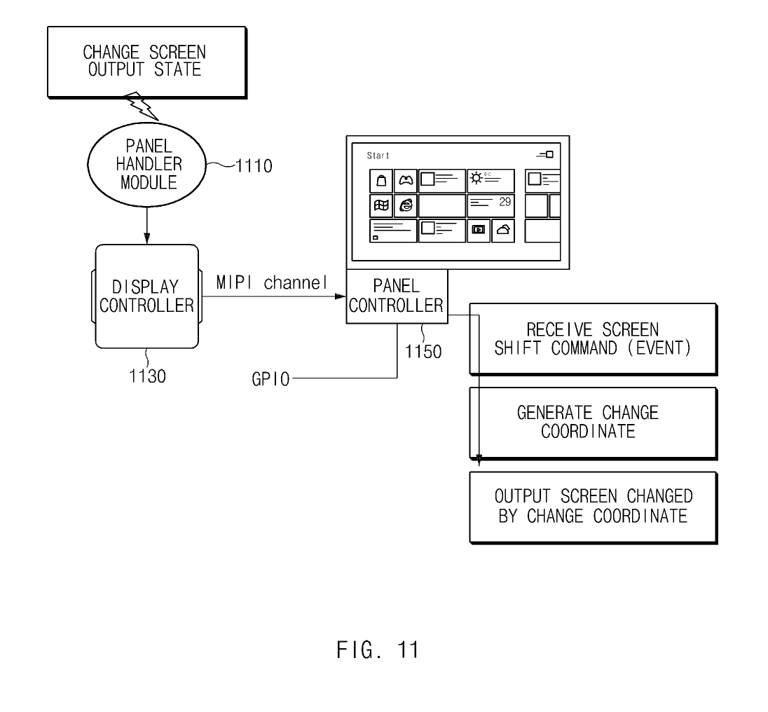

The processor 210 may have the same or similar configuration to that of a processor 110 shown in FIG. 1. According to various embodiments of the present disclosure, the processor 210 may include a panel handler module 211 or a touch control module 213. The processor 210 may perform a function of collecting, storing, converting, or outputting display data, through the panel handler module 211. For example, as shown in FIG. 11, if a screen output state change event (e.g., an LCD turn-on/off event, a screen rotation event, or a screen conversion event, and the like) occurs, the processor 210 may send the event to the display controller 220 through the panel handler module 211 to process related display data. Also, the processor 210 may perform a function of recognizing or changing a touch coordinate of the touch panel 260, through the touch control module 213. For example, the processor 210 may send the event, related change coordinate information, and the like to the touch controller 250 through the touch control module 213 to recognize or change a touch coordinate corresponding to a changed position in connection with changing a display position of display data.

According to various embodiments of the present disclosure, the processor 210 may be configured in the form of including at least one or more components included in a module (e.g., a display data processing module 130 of FIG. 1) associated with processing display data. Also, the processor 210 may be configured in the form of including the display controller 220, such as a graphic processing unit (GPU), for exclusively processing display data to convert display data in various ways or quickly process the display data. The display controller 220 may include a separate processor, a control circuit (or a control device), or a storing medium, and the like in connection with processing display data.

The display controller 220 may receive a display data related event, for example, the screen output state change event (e.g., the LCD turn on/off event, the screen rotation event, or the screen conversion event, and the like) from the processor 210 and may perform a function of collecting, converting, or outputting display data. Also, the display controller 220 may receive a display data output state change event from the processor and may adjust a color of display data, may blur the display data, or adjust luminance of the display data. According to an embodiment of the present disclosure, the display controller 220 may include at least one or more components included in the display data processing module 130 shown in FIG. 1. Also, the display controller 220 may send display data to the panel controller 230.

The panel controller 230 may receive display data or a display data related event from the display controller 220. According to an embodiment of the present disclosure, the panel controller 230 may communicate data with the display controller 220 through a communication interface. For example, the panel controller 230 may receive display data or a display data related event from the display controller 220 through a communication interface such as a mobile industry processor interface (MIPI) or a mobile display digital interface (MDDI). Alternatively, the panel controller 230 may receive an electric input corresponding to a display data related event through a general purpose input/output (GPIO) and may perform a function of converting or outputting display data.

According to various embodiments of the present disclosure, if the screen output state change event occurs, the panel handler module 211 may detect the occurrence of the screen output state change event and may control screen shift, that is, a change of a display position of display data. Also, if the display data output state change event occurs, the panel handler module 211 may control a change of display data. According to an embodiment of the present disclosure, the panel handler module 211 may send an MIPI command, associated with changing display data, through the display controller 220. Alternatively, the panel handler module 211 may directly control a GPIO signal and may send a command, associated with changing display data, to the panel controller 230.

According to various embodiments of the present disclosure, the panel controller 230 may store received display data in a storing medium which is included in the panel controller 230 or is connected with the panel controller 230. According to an embodiment of the present disclosure, the panel controller 230 may include a storing medium for a display buffer to store display data or display data for each frame output on a screen area of a specific or larger size.

According to an embodiment of the present disclosure, the panel controller 230 may convert received or stored display data into an image signal. Also, the panel controller 230 may output the converted image signal to the display panel 240. In this regard, the panel controller 230 may include a drive IC for providing a drive signal and an image signal to the display panel 240 or a timing controller for controlling display data and data (e.g., a drive signal and an image signal) sent to the driver IC. The driver IC may include a gate driver IC for sequentially selecting a gate signal wire of the display panel 240 and generating a scan signal (or a drive signal) and a data driver IC (or a source driver IC) for applying an image signal to a data signal wire. For example, if the gate driver IC selects a scan line (or a gate signal wire), applies a scan signal, and makes a corresponding element activated, the source driver IC may apply an image signal to the corresponding element through each data signal wire.

According to an embodiment of the present disclosure, the timing controller may convert display data into an image signal and may generate a drive signal based on the display data. Also, the timing controller may adjust a time when data is sent to the driver IC to prevent a display time difference which may occur in a process of being output on a screen. According to various embodiments of the present disclosure, the timing controller may be configured in the form of including the display controller 220 or including at least one or more components included in the display controller 220. For example, the timing controller may receive a display data related event from the processor 210 or the display controller 220 and may perform a function of collecting, converting, or outputting display data in response to the event.

The display panel 240 may include elements which may express a color and the like based on an image signal received from the panel controller 230. The elements constitutes pixels of the display panel 240 and may include a fluorescent material or an organic fluorescent material, and the like which may express a color.

The touch controller 250 may perform a function of recognizing or changing a touch coordinate. According to an embodiment of the present disclosure, the touch controller 250 may receive a user input (or a touch, hovering, and the like) through the touch panel 260. In this case, the touch controller 250 may determine a touch coordinate based on input information and may send the determined touch coordinate to the processor 210. Also, the touch controller 250 may receive an event, associated with changing a display position of display data, and a coordinate value of a changed position (or a moved coordinate value) from the processor 210. Also, the touch controller 250 may change a related touch coordinate based on the coordinate value.

The touch panel 260 may perform a function of receiving an input from a user. The touch panel 260 may use at least one of a capacitive type, a resistive type, an infrared type, or an ultrasonic type. For example, the touch panel 260 may use the capacitive type of detecting a change of capacitance of a conductive film, the resistive type of measuring a pressure change by a pressure sensor, the infrared type of detecting the blocking-out of light using infrared rays, or the ultrasonic type of detecting a level of sound waves blocked by an object. According to an embodiment of the present disclosure, the touch panel 260 may further include a tactile layer and may provide a tactile reaction to the user. According to various embodiments of the present disclosure, the touch panel 260 may be configured in the form of including the touch controller 250. Also, the touch panel 260 and the display panel 240 may be configured as one module.

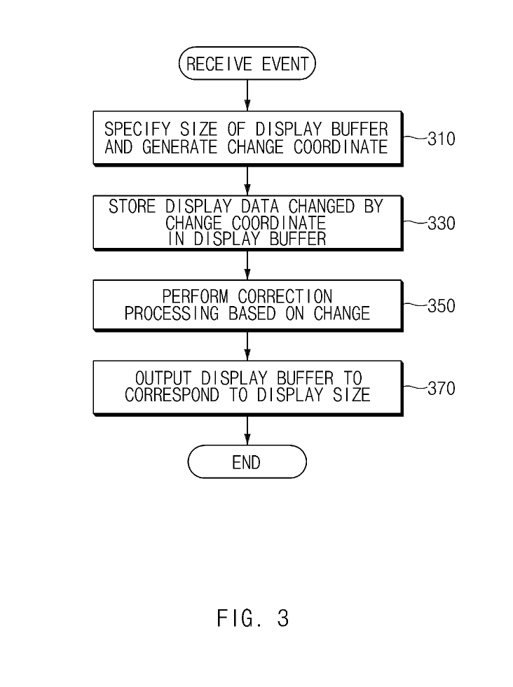

FIG. 3 is a flowchart illustrating an electronic device operating method associated with processing display data upon receiving a screen output state change event based on an embodiment of the present disclosure. To prevent a burn-in phenomenon, an electronic device (e.g., an electronic device 101 of FIG. 1 or an electronic device 200 of FIG. 2) having the above-mentioned components may change a display position of display data to be output in a state where a user may not recognize screen shift easily, for example, if an output state of a screen area of a specific size or larger is changed.

In connection with the above-mentioned functions, referring to FIG. 3, in an electronic device operating method, the electronic device may process a screen output state change event for changing an output state of a screen area of a specific or larger size. For example, the electronic device may process an event associated with LCD turn on/off, screen rotation, or screen conversion, and the like. Also, the electronic device may generate a display buffer to store display data.

In response to receiving the event, in operation 310, the electronic device may specify a size (or length) of a display buffer to store display data. According to an embodiment of the present disclosure, the electronic device may specify a size (or length) of the display buffer to be the same as that of display data or be larger by a specific size (e.g., a size of a degree to which the user may not recognize a screen change). Also, the electronic device may generate a change coordinate value for changing a display position of display data. According to an embodiment of the present disclosure, the electronic device may randomly generate the coordinate value within a range of a degree to which the user may not recognize a screen change.

In operation 330, the electronic device may store display data, collected from an application program or an OS which uses or occupies a screen, in the display buffer to correspond to a changed position based on the generated coordinate value. According to an embodiment of the present disclosure, the electronic device may change display position information included in the collected display data based on the coordinate value and may store the changed display data in the display buffer. Alternatively, the electronic device may store the display data in the display buffer and may change display position information included in the stored display data based on the coordinate value. In this case, a display blank phenomenon where there is no display data to be displayed on specific pixels of a display based on a screen change or a phenomenon where display data to be displayed is not displayed and is cut because of departing from a size range of a display buffer may occur.

Since a screen is asymmetrically displayed due to the above-mentioned phenomenon, in operation 350, the electronic device may perform correction processing based on a change of a display position of display data. According to an embodiment of the present disclosure, the electronic device may output display data having specific information on a display blank area of a screen. For example, the electronic device may copy display data output on the display blank area before changing a display position of display data and may store the copied display data in a display buffer to correspond to the display blank area. Alternatively, the electronic device may delete display data of a position which is symmetrical about the display blank area on a display position from the display buffer or may not store the corresponding display data in the display buffer in operation 330.

According to various embodiments of the present disclosure, to prevent the above-mentioned phenomenon, in operation 330, the electronic device may scale display data to be stored and may store the scaled display data. For example, the electronic device may adjust a display size of display data to be proportionally smaller and may store the adjusted display data to prevent a phenomenon where display data to be displayed is cut in a process of displaying the display data. In this regard, the electronic device may specify the size adjustment at a rate of a degree to which the user may not recognize the size adjustment. In this case, the electronic device may process the display blank area, which may be generated based on a change of a display position of display data, by the same or similar method to the above-mentioned method.

According to various embodiments of the present disclosure, in operation 310, the electronic device may specify a size of a display buffer to store display data to be larger by a specific size to prevent the display blank area from being generated. For example, the electronic device may specify a size of a display buffer to be larger by a size of a degree to which the user may not recognize a screen change (e.g., a degree corresponding to a specific rate (e.g., less than 1%) to screen resolution). Also, the electronic device may store display data to be displayed in the display buffer and may process a portion where the display data is not stored (e.g., a portion which is extended by a size corresponding to a specific rate to screen resolution) such that the corresponding portion has the same or similar information to display data displayed on an area adjacent to a region to be displayed on a screen.

In operation 370, the electronic device may output the corrected display data on a display (e.g., a display 150 of FIG. 1). According to various embodiments of the present disclosure, the electronic device may output the display data on a display (e.g., a display 170 of FIG. 1) included in an external electronic device (e.g., an external electronic device 102 of FIG. 1) connected through wired and wireless communication.

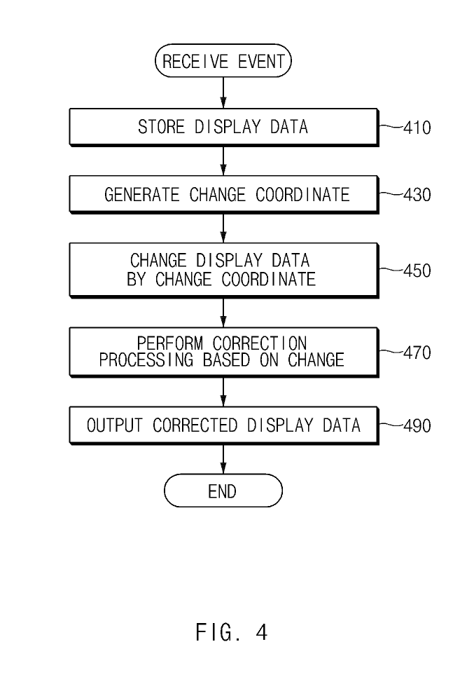

FIG. 4 is a flowchart illustrating an electronic device operating method for processing display data based on a panel controller (e.g., a panel controller 230 of FIG. 2) upon receiving a screen output state change event based on an embodiment of the present disclosure.

Referring to FIG. 4, in an electronic device operating method, an electronic device (e.g., an electronic device 200 of FIG. 2) may process a screen output state change event for changing an output state of a screen area of a specific or larger size. According to an embodiment of the present disclosure, the electronic device may perform a function of collecting or converting display data based on the panel controller (e.g., the panel controller 230), rather than performing the function of collecting or converting the display data based on a display controller (e.g., a display controller 220 of FIG. 2) included in the electronic device, in connection with processing the event. For example, the panel controller may receive the event from a processor or the display controller and may perform the function.

In response to receiving the event, in operation 410, the panel controller may collect display data from the processor or the display controller and may store the collected display data in a storing medium (e.g., a storing included in the panel controller or a storing medium connected with the panel controller). The storing medium may include a display buffer for storing display data. According to an embodiment of the present disclosure, the processor or the display controller may store display data in the storing medium or a separate storing medium (e.g., a storing medium included in the processor or the display controller or a storing medium connected with the processor or the display controller) at the same time as or immediately before sending the event to the panel controller. In this case, the panel controller may collect and use the display data stored in the storing medium or the separate storing medium. Alternatively, if display data is stored in the separate storing medium, the panel controller may collect the display data stored in the separate storing medium and may store the collected display data in the storing medium.

In operation 430, the panel controller may generate a change coordinate value for changing a display position of display data. According to an embodiment of the present disclosure, the panel controller may randomly generate the change coordinate value within a range of a degree to which a user may not recognize a screen change. In this regard, the range of the degree to which the user may not recognize the screen change may be specified based on at least one of a specified range, a size of a pixel, density of a pixel, screen resolution, or position relationship between the user and an electronic device based on an experimental value for a related range. According to an embodiment of the present disclosure, the panel controller may determine a screen shift length of a degree to which the user may not recognize screen shift. For example, when each of pixels configuring a screen is smaller in size, when each of pixels is higher in density, when screen resolution is higher, when a viewing angle on a screen is wider, or when a viewing distance from the screen is longer, an amount of pixel shift on the screen may be relatively larger. In this case, the panel controller may generate the change coordinate value corresponding to a display coordinate (e.g., an x-axis or y-axis coordinate) of a screen based on the screen shift length.

If generating the change coordinate value, in operation 450, the panel controller may change display position information of display data stored in a display buffer to correspond to a change position based on the change coordinate value. According to an embodiment of the present disclosure, the panel controller may perform an operation corresponding to operation 450 or 410 after performing operation 430. For example, the panel controller may generate a change coordinate value for changing a display position of display data and may store collected display data in the display buffer to correspond to a change position based on the change coordinate value, or may change display position information of collected display data and may store the changed display data in the display buffer.

As described above, if an operation of changing a display position of display data is performed, a display blank phenomenon where there is no display data to be displayed on a specified area of a screen or a phenomenon where display data is cut because of departing from a size range of a display buffer may occur. In this case, in operation 470, the panel controller may perform correction processing based on a screen change. In this regard, the correction processing may be the same or similar to operation 350 of FIG. 3.

In operation 490, the panel controller may convert the display data through the correction processing into an image signal and may output the converted image signal to a display panel (e.g., a display panel 240 of FIG. 2). According to various embodiments of the present disclosure, the processor may correct a touch coordinate of a touch panel (e.g., a touch panel 260 of FIG. 2) included in the electronic device, in connection with changing a display position of display data at the same time as performing operation 470 or 490 or at intervals of a specific time. For example, the processor may change a touch coordinate value, recognized through a user input by the touch panel, based on the change coordinate value through a touch controller (e.g., a touch controller 250 of FIG. 2).

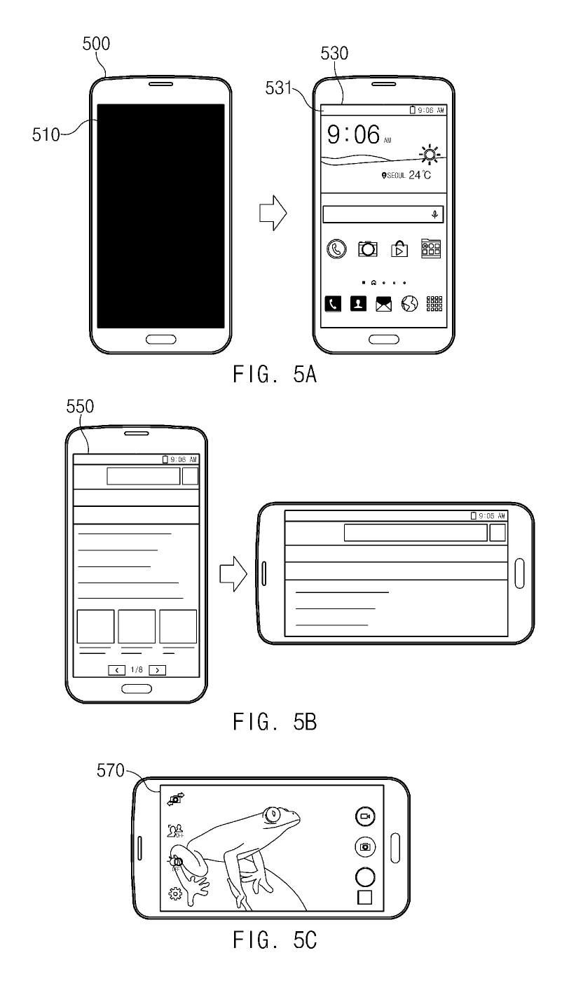

FIG. 5A is a drawing illustrating an LCD turn-on/off event among screen output state change events based on an embodiment of the present disclosure. FIG. 5B is a drawing illustrating a screen rotation event among screen output state change events based on an embodiment of the present disclosure. FIG. 5C is a drawing illustrating a screen shift event among screen output state change events based on an embodiment of the present disclosure. According to various embodiments of the present disclosure, if the same screen is displayed during a specific time or more on a specified screen area, for example, if an indicator bar 531 is displayed during a specific time or more on an upper area of a screen 530, a burn-in phenomenon where a specific pixel configuring a display (e.g., a display 150 of FIG. 1) does not output specified display data or outputs display data having different information from specified display data may occur in an electronic device 500. As shown in FIG. 5A, as a screen 510 is changed from a turned-off state to a turn-on state, when an output state of a screen area of a specific or larger size is changed, the electronic device 500 may change a display position of related display data to prevent this phenomenon.

In this regard, referring to FIGS. 5A to 5C, the electronic device 500 according to various embodiments of the present disclosure may process the screen output state change event. For example, as shown in FIG. 5A, the electronic device 500 may display a state where the screen 510 is turned off (e.g., a state where a screen is not displayed). According to various embodiments of the present disclosure, the electronic device 500 may output display data on the screen 530 based on occurrence of a turn-on related event. The turn-on related event may include, for example, an event of receiving an incoming call, an event of receiving a short message service/multimedia message service (SMS/MMS), an alarm/timer event, or an event of receiving a user input such as a power button input. In this case, the electronic device 500 may change a display position of display data to be displayed and may output the changed display data.

Also, as shown in FIG. 5B, if a screen 550 rotates, the electronic device 500 may change a display position of display data. According to various embodiments of the present disclosure, if an output state of a screen area of a specific or larger size is changed, for example, if the screen 510 is changed from a turned-off state to a turn-on state or if the screen 550 rotates, a user may not recognize a screen change, based on a change of a display position of display data, easily.

If various events other than the LCD turn-on/off event or the screen rotation event described above occur, the output state of the screen area of the specific or larger size is changed. For example, as shown in FIG. 5C, if a screen 570 is converted by performing a camera function included in the electronic device 500, an output state of a screen area of a specific or larger size may be changed. Also, although not illustrated, an output state of a screen area of a specific or larger size may be changed by performing a full screen mode while a video play function included in the electronic device 500 is performed. In addition, if an output state of a screen area of a specific or larger size is changed through screen conversion and the like, the electronic device 500 may change a display position of display data.

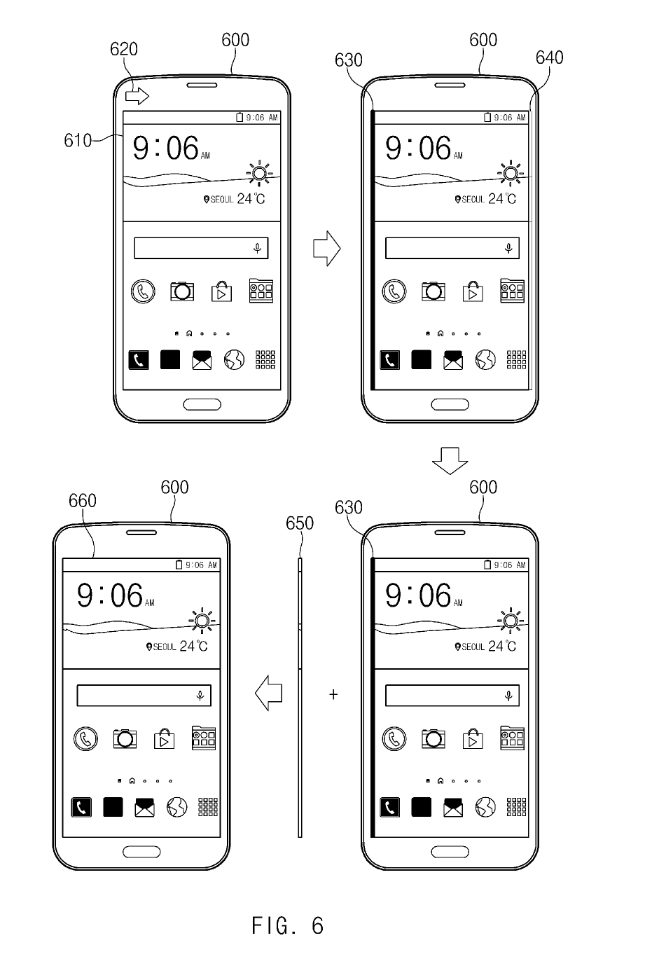

FIG. 6 is a drawing illustrating a method for processing a display blank area among correction processing methods based on a change of a display position of display data based on an embodiment of the present disclosure.

Referring to FIG. 6, if a screen area 610 is changed by a specific or larger size, an electronic device 600 may a display position of display data. According to an embodiment of the present disclosure, the electronic device 600 may perform operation 620 of changing a display position of display data and moving display data output on the screen area 610. In FIG. 6, an embodiment of the present disclosure is exemplified as operation 620 is displayed as an operation moved to an x-axis on a screen. However, the scope and spirit of the present disclosure may not be limited thereto. For example, operation 620 may be an operation moved to a y-axis on the screen. For example, operation 620 may be an operation simultaneously moved to the x-axis and the y-axis.

In connection with performing operation 620, a display blank region 630 generated because there is no display data to be displayed on a specific pixel of a display (e.g., a display 150 of FIG. 1) based on a change of a display position of display data or a region 640 where display data to be displayed is not displayed and is cut may be generated. In this regard, the electronic device 600 may perform correction processing to compensate the display blank region 630.

According to various embodiments of the present disclosure, the electronic device 600 may display specific display data on the display blank region 630 such that a user may not recognize a screen change easily. According to an embodiment of the present disclosure, the electronic device 600 may extract display data 650, output on the display blank region 630, from a display buffer before performing operation 620. Also, the electronic device 600 may store the display data, extracted at the same time as or immediately after performing operation 620, in a display buffer to correspond to the display blank region 630 and may output the display data 650 stored in the display buffer on a display. In this regard, the electronic device 600 may determine the display blank region 630 based on a position change coordinate value of display data at the same time as or immediately after performing operation 620. The electronic device 600 may output a corrected screen 660 through the above-mentioned method.

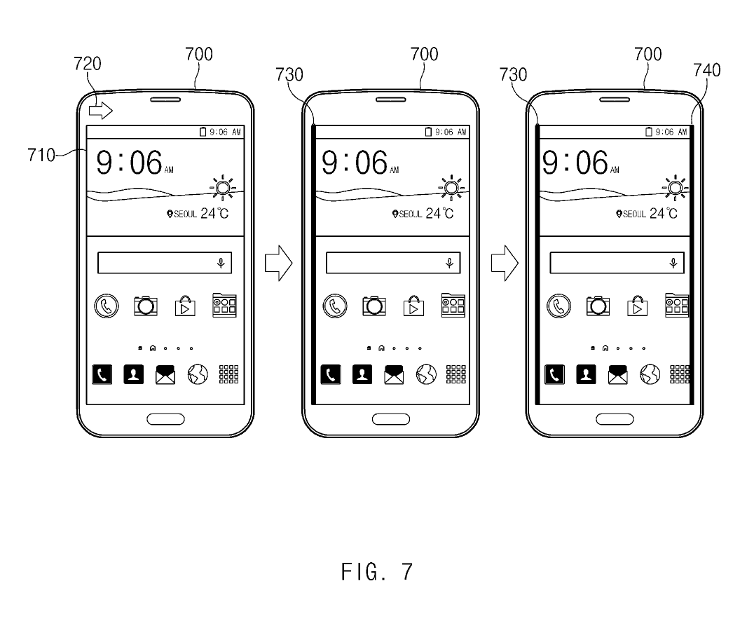

FIG. 7 is a drawing illustrating a method for deleting a region matched with a display blank region among correction processing methods based on a change of a display position of display data based on an embodiment of the present disclosure.

Referring to FIG. 7, an electronic device 700 may perform operation 720 of changing a display position of display data and moving display data output on a screen region 710. In connection with performing operation 720, a display blank region 730 or a cut region (not shown) may be generated based on a change of a display position of display data.

According to various embodiments of the present disclosure, the electronic device 700 may display the same or similar display data to display data, output on the display blank region 730, on a region 740 which is symmetrical about the display blank region 730 on a display position of the screen region 710 to be different from displaying the display blank region 730 with specific display data through the above-mentioned method. Alternatively, the electronic device 700 may delete display data, output on the symmetrical region 740, from a display buffer or may not output the display data on a display. According to an embodiment of the present disclosure, the electronic device 700 may not store display data in a portion of a display buffer corresponding to the symmetrical region 740 in connection with performing operation 720. In this regard, the electronic device 700 may determine the region 740, which is symmetrical about the display blank region 730, based on a position change coordinate value of display data at the same time as or immediately before performing operation 720.

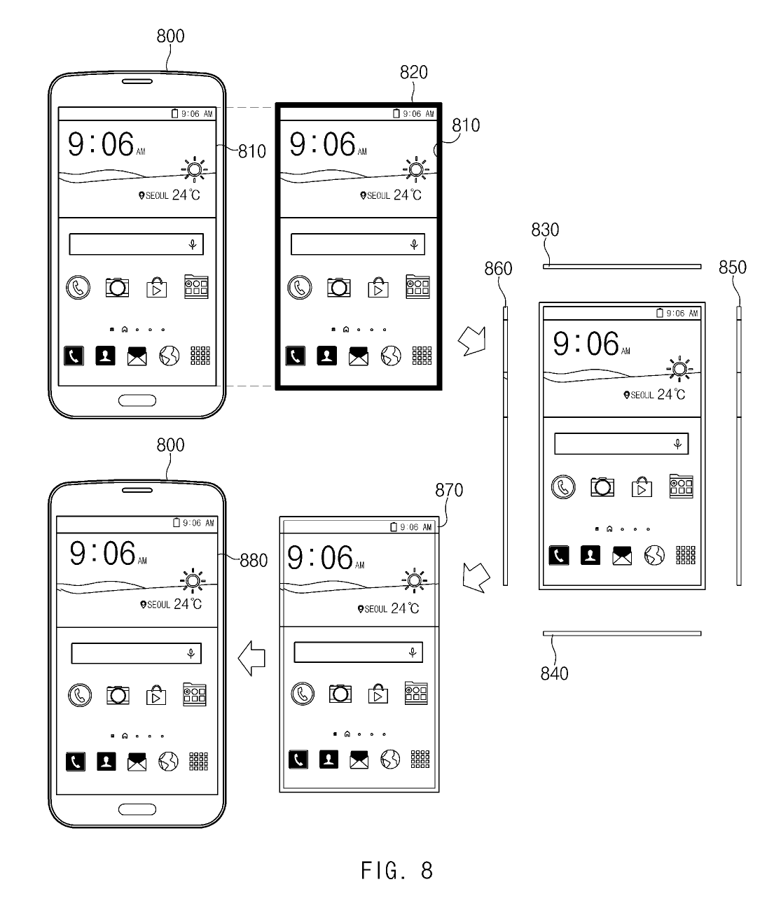

FIG. 8 is a drawing illustrating a method using a display buffer which is larger than display data in size based on an embodiment of the present disclosure.

Referring to FIG. 8, an electronic device 800 may output display data on a screen region 810. As described above, if a display position of display data is changed, a display blank region or a cut region may be generated. However, if a screen change is generated a specific number or more of times during a specific time, a method of displaying the display blank region with specific display data to correct the display blank region, displaying a region, symmetrical about the display blank region on a screen display position, with display data displayed on the display blank region, or not displaying a region which is symmetrical about the display blank region on the screen display region may hold a load on a device for changing a display position of display data.

According to various embodiments of the present disclosure, the electronic device 800 may use a display buffer which is larger than that of display data by a specific size, for example, a size of a degree to which a user may not recognize a change of the screen region 810 easily. For example, the electronic device 800 may specify a size of a display buffer to be larger by a specific or larger size to correspond to a region 820 which is larger than the screen region 810. In this case, the electronic device 800 may store display data in a display buffer to correspond to a specified region of the region 820 (e.g., a region which maintains a specific separation distance from a periphery of the region 820). Alternatively, the electronic device 800 may sequentially store display data in a display buffer based on display position information of display data changed based on a position change coordinate value.

According to various embodiments of the present disclosure, the electronic device 800 may store specific display data in a display buffer portion which remains after display data is stored in a display buffer. According to an embodiment of the present disclosure, the electronic device 800 may store the same or similar display data to display data, located on a region adjacent to a region to display the remaining display buffer portion, in the remaining display buffer portion. For example, the electronic device 800 may store the same or similar display data 830 to display data, output on an upper region of the screen region 810, in a portion corresponding to an upper region of the region 820 in the remaining display buffer portion. Also, similarly, the electronic device 800 may store the same or similar display data 840 to display data output on a lower region of the screen region 810, the same or similar display data 850 to display data output on a right region of the screen region 810, and the same or similar display data 860 to display data output on a left region of the screen region 810, in the remaining display buffer portion to correspond to a related region of the region 820. As described above, if storing the remaining display buffer portion with specific display data, as shown in a screen 870, the electronic device 800 may have a display buffer which stores display data of a degree to which the user may not recognize a screen change.

According to various embodiments of the present disclosure, the electronic device 800 may output a screen 880 in connection with changing a display position of display data. In this case, the electronic device 800 may prevent a display blank region which may be generated based on a change of a display position of display data. Also, since the same screen outputs display data using the same display buffer although a display position is changed a specific number or more of times during a specific time, the electronic device 800 may omit a correction processing operation, such as an operation of storing display data, for a display blank region.

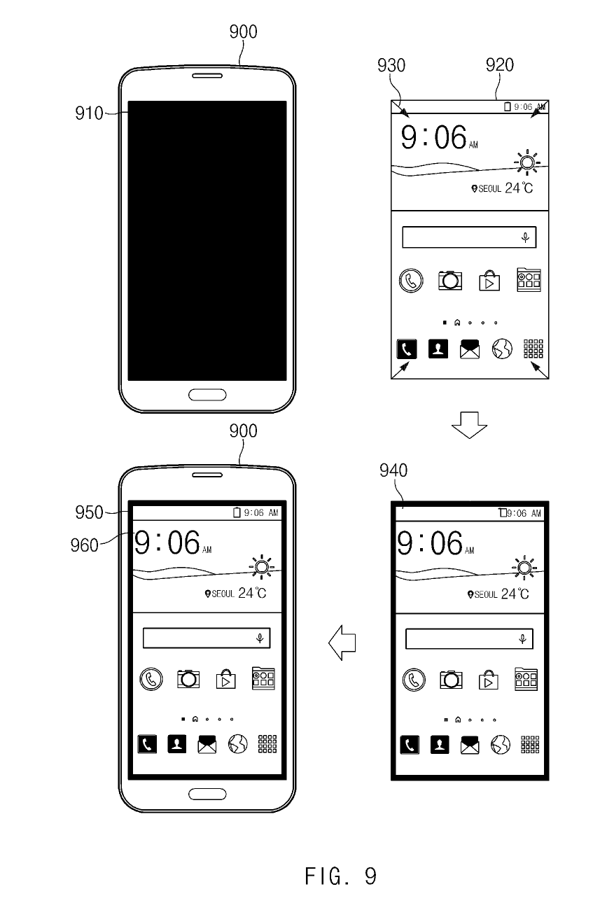

FIG. 9 is a drawing illustrating a method for scaling and displaying display data based on an embodiment of the present disclosure.

Referring to FIG. 9, an electronic device 900 may output display data on a screen region 910. As described above, if a display position of display data is changed, a phenomenon where display data to be output is not displayed and is cut because of departing from a screen may occur. In this case, the electronic device 900 may not send information to its user.

According to various embodiments of the present disclosure, the electronic device 900 may adjust a display size of display data to be output on the screen region 910 to be proportionally smaller through a scaling operation 930 and may store the adjusted display data in a display buffer. For example, a screen display region 920 before a display size of display data is changed may be adjusted to a screen display region 940 through scaling operation 930 to be smaller. In this case, although a display position of display data is changed, the electronic device 900 may prevent a phenomenon where display data is not displayed and is cut.

According to various embodiments of the present disclosure, the electronic device 900 may change a display position of a screen display region 960 in the entire screen region 950 in response to a change of a display position of display data. According to an embodiment of the present disclosure, the electronic device 900 may process a display blank region, generated by difference between the entire screen region 950 and the screen display region 960 of the display data, by the same or similar method to the above-mentioned correction processing method.

As described above, according to various embodiments of the present disclosure, an electronic device may include a display, a memory configured to store display data output on the display, and a processor configured to operatively connect with the display and the memory. If a screen output state change event for changing an output state of a screen area of a designated size or more occurs, the processor may be configured to change a display position of display data outputted on the screen area and to output the display data on the display based on the changed display position.

According to various embodiments of the present disclosure, if an event for changing the display from a turn-off state to a turn-on state occurs, if an event for rotating a screen of the display occurs, or if an event for outputting display data different from display data previously outputted on the screen area occurs, the processor may be configured to change the display position of the display data outputted on the screen area and to output the display data on the display based on the changed display position.

According to various embodiments of the present disclosure, the processor may be configured to output an additional display data on a display blank area induced by the change of the display position of the display data. The additional display data may be previously outputted on an area corresponding to the display blank area of the screen area before changing the display position of the display data or outputted on an area adjacent to the display blank area.

According to various embodiments of the present disclosure, the processor may be configured to control not to output the display data on an area which is symmetrical on the display position with respect to the display blank area induced by the change of a display position of the display data.

According to various embodiments of the present disclosure, the processor may be configured to generate a display buffer which is larger than the display data by a designated size, to store the display data in the display buffer, to store the same or similar display data to display data, output on an area adjacent to a screen display area to display a portion which remains after the display data is stored, in the remaining portion, and to output the display buffer.

According to various embodiments of the present disclosure, the processor may be configured to adjust a display size of the display data to be proportionally smaller, to output the adjusted display data, and to output an additional display data on a display blank area induced by the change of the display position of the display data and the adjustment of the display size of the display data. The additional display data is previously outputted on an area corresponding to the display blank area of the screen area before changing the display position of the display data or outputted on an area adjacent to the display blank region.

According to various embodiments of the present disclosure, the electronic device may further include a panel controller configured to process the display data or an image signal into which the display data is converted. The panel controller may be configured to change a display position of display data outputted on the screen area rather than the processor. According to various embodiments of the present disclosure, the panel controller may receive the display data or the screen output state change event from a processor or a display controller, included in the electronic device or an external electronic device connected with the electronic device through wired and wireless communication, through a communication interface or to receive the screen output state change event from the processor or the display controller through a general purpose input/output (GPIO).

According to various embodiments of the present disclosure, the panel controller may obtain the display data from a storing medium included in the electronic device or the external device in response to receiving the screen output state change event.

According to various embodiments of the present disclosure, the electronic device may correct a touch coordinate of a touch panel, included in the electronic device or an external electronic device connected with the electronic device through wired and wireless communication, based on a changed display position of the display data.

FIG. 10 is a drawing illustrating a screen for changing a display position of display data in response to occurrence of a screen output state change event based on an embodiment of the present disclosure.

Referring to FIG. 10, in operation 1010, an electronic device (e.g., an electronic device 101 of FIG. 1) may receive a screen output state change event. For example, if an output state of a screen region of a specified range or more is changed, for example, an LCD is changed from a turned-off state to a turn-on state, if a screen rotates, or if a screen is converted, the electronic device may receive a screen output state change event.

If receiving the event, in operation 1030, the electronic device may generate a coordinate value (e.g., an x-axis and/or y-axis coordinate value) corresponding to a changed position (or a moved position) in connection with changing a display position of display data. According to an embodiment of the present disclosure, the electronic device may generate the coordinate value based on at least one of a specific value, a size of a pixel, density of a pixel, screen resolution, or position relationship between a user of the electronic device and the electronic device.

In operation 1050, the electronic device may change a display position of display data to correspond to the coordinate value. Also, the electronic device may display a new screen based on the changed information. For example, the electronic device may change a screen 1070 output before receiving the event to a screen 1090 moved to correspond to the coordinate value and may output the screen 1090.

FIG. 11 is a drawing illustrating a screen associated with a screen output state change event based on an embodiment of the present disclosure.

Referring to FIG. 11, an electronic device (e.g., an electronic device 200 of FIG. 2) may receive a screen output state change event. For example, the electronic device may detect an event, such as an LCD turning-on event, a screen rotation event, or a screen conversion event, through a panel handler module 1110. Also, the electronic device may change a display position of display data in response to occurrence of the screen output state change event. For example, the electronic device may send a command for a screen shift to a panel controller 1150 (e.g., a panel control integrated circuit (IC)) to change a display position of display data.

According to various embodiments of the present disclosure, the electronic device may send the command for the screen shift, for example, a mobile industry processor interface (MIPI) command to the panel controller 1150 through a display controller 1130. For example, the electronic device may send the command for the screen shift to the panel controller 1150 through a communication channel (e.g., a MIPI channel) connected between the display controller 1130 and the panel controller 1150. Also, the electronic device may directly control a general purpose input/output (GPIO) signal through the panel handler module 1110 and may send the command for the screen shift to the panel controller 1150.

As described above, according to various embodiments of the present disclosure, a method for processing display data in an electronic device may include changing a display position of display data outputted on a screen area, if a screen output state change event for changing an output state of the screen area of a designated size or more occurs and outputting the display data on a display based on the changed display position.

According to various embodiments of the present disclosure, the changing of the display position of the display data may include changing the display position of the display data outputted on the screen area, if an event for changing the display from a turn-off state to a turn-on state occurs, if an event for rotating a screen of the display occurs, or if an event for outputting display data different from display data previously outputted on the screen area occurs.

According to various embodiments of the present disclosure, the method may further include outputting an additional display data on a display blank area induced by the change of the display position of the display data. The additional display data may be previously outputted on an area corresponding to the display blank area of the screen area before changing the display position of the display data or outputted on an area adjacent to the display blank area.

According to various embodiments of the present disclosure, the method may further include controlling not to output the display data on an area which is symmetrical on the display position with respect to the display blank area induced by the change of the display position of the display data.

According to various embodiments of the present disclosure, the method may further include generating a display buffer which is larger than the display data by a designated size, storing the display data in the display buffer, storing the same or similar display data to display data, output on an area adjacent to a screen display area to display a portion which remains after the display data is stored, in the remaining portion, and outputting the display buffer.

According to various embodiments of the present disclosure, the method may further include adjusting a display size of the display data to be proportionally smaller and outputting the adjusted display data and outputting an additional display data on a display blank area induced by the change of the display position of the display data and the adjustment of the display size of the display data. The additional display data may be previously outputted on an area corresponding to the display blank area of the screen area before changing the display position of the display data or outputted on an area adjacent to the display blank area.

According to various embodiments of the present disclosure, the changing of the display position of the display data may further include an operation performed by a panel controller which processes the display data or an image signal into which the display data is converted.

According to various embodiments of the present disclosure, the operation performed by the panel controller may include receiving the display data or the screen output state change event from a processor or a display controller, included in the electronic device or an external electronic device connected with the electronic device through wired and wireless communication, through a communication interface or receiving the screen output state change event from the processor or the display controller through a GPIO.

According to various embodiments of the present disclosure, the operation performed by the panel controller may further include obtaining the display data from a storing medium, included in the electronic device or the external electronic device, in response to the reception of the screen output state change event.

According to various embodiments of the present disclosure, the method may further include correcting a touch coordinate of a touch panel, included in the electronic device or an external electronic device connected with the electronic device through wired and wireless communication, based on a changed display position of the display data.

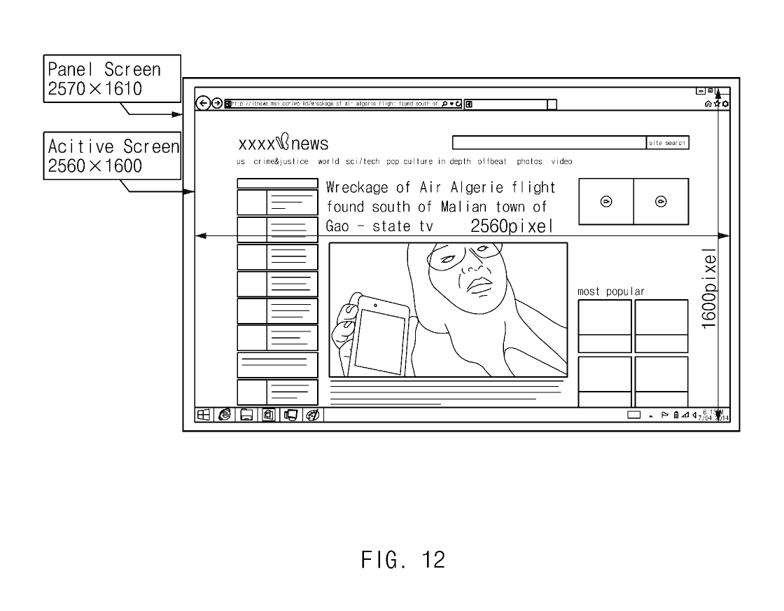

FIG. 12 is a drawing illustrating a screen associated with setting a size of a display panel based on an embodiment of the present disclosure.

Referring to FIG. 12, an electronic device (e.g., an electronic device 200 of FIG. 2) may have a display panel region (e.g., a panel screen) which is larger than a region (e.g., an active screen), which outputs display data, by a specific size. For example, the electronic device may include a display panel set to be larger by a specific rate (e.g., less than about 1%) of a degree to which a user may not recognize a gap between the active screen and the panel screen easily. In FIG. 12, an embodiment of the present disclosure is exemplified as a screen in which the panel screen is set to have resolution of 2570×1610 if the active screen which is an actually output screen follows a display standard having resolution of a wide quad extended graphics array (WQXGA) (2560×1600).

According to various embodiments of the present disclosure, as described above, the electronic device may output display data without change on the panel screen without the necessity of adjusting a size of the active screen to be smaller by a specific rate (e.g., scaling display data to be smaller by a specific rate) by setting the panel screen to be larger than the active screen by a specific size. Therefore, the electronic device does not resize display data, thus preventing an image dot phenomenon (e.g., a phenomenon where a specified portion of an image is displayed as dots) and the like. Also, the electronic device may move display data by an x-axis value and a y-axis value randomly generated as a value which is smaller than a gap between the panel screen and the active screen in response to occurrence of the screen output state change event and may output the moved display data.

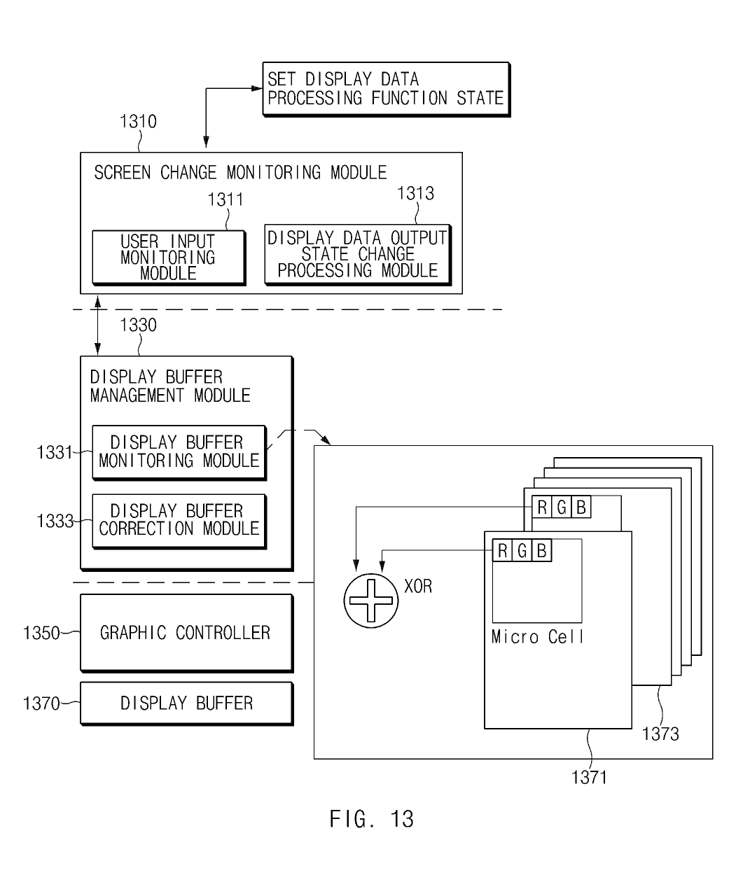

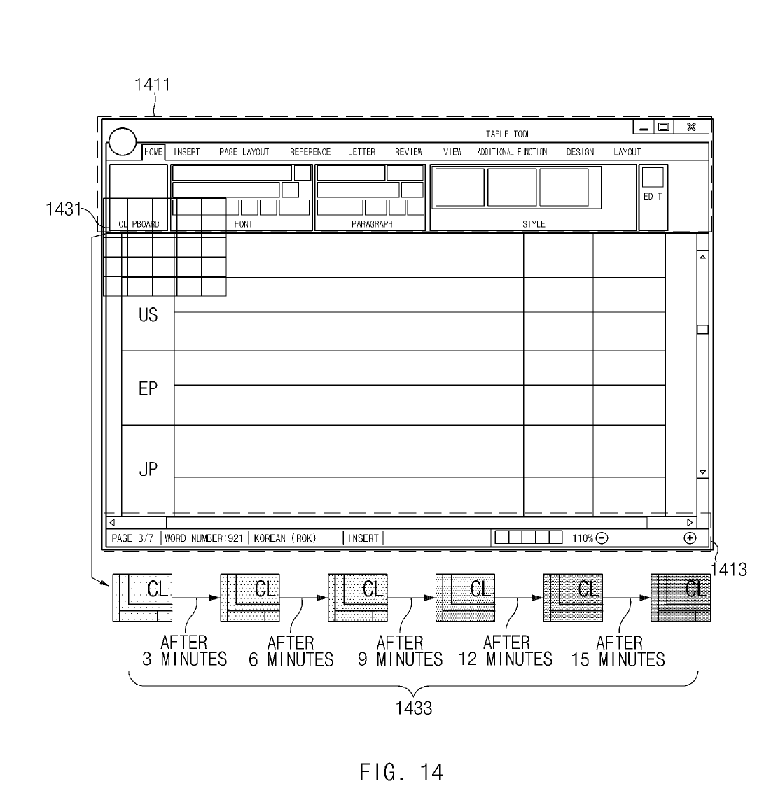

FIG. 13 is a block diagram illustrating a configuration of an electronic device associated with changing display data based on an embodiment of the present disclosure. If at least part of a screen is not changed during a specific time, a bum-in phenomenon, where a color is not expressed properly because a fluorescent material or an organic fluorescent material configuring pixels of the corresponding part is excessively used, may occur in an electronic device (e.g., an electronic device 200 of FIG. 2). To prevent the above-mentioned burn-in phenomenon, the electronic device may change display data output on the screen region which is not changed during the specific time.

Referring to FIG. 13, the electronic device may include a screen change monitoring module 1310, a display buffer management module 1330, a graphic controller 1350, and a display buffer 1370. The above-mentioned components may be components for describing performing a function associated with changing an output state of display data. The electronic device may further include components other than the above-mentioned components. Alternatively, at least one of the above-mentioned components may be omitted from the electronic device.

The screen change monitoring module 1310 may verify a change on a screen. If a change on the screen does not occur during a specific time, the screen change monitoring module 1310 may change display data. The screen change monitoring module 1310 may include a user input monitoring module 1311 and a display data output state change processing module 1313. The user input monitoring module 1311 may determine whether a user input such as a user touch input or a position of a mouse cursor is received. Also, the user input monitoring module 1311 may determine a screen position on which a user input is generated and may send a user input receiving event including information about the determined screen position to the screen change monitoring module 1310.

According to various embodiments of the present disclosure, if the user input receiving event occurs, the screen change monitoring module 1310 may verify a change on a screen based on information about a screen position on which a user input is generated. Also, if receiving a display data change event is received from the display buffer management module 1330, the screen change monitoring module 1310 may verify a change on a screen. The screen change monitoring module 1310 may determine whether an output state of display data corresponding to a changed position on the screen (e.g., a screen position on which a user input is generated) is a changed state.

The display data output state change processing module 1313 may change display data. For example, the display data output state change processing module 1313 may change an output state of display data through a change of color information of display data, blurring of the display data, or a change of luminance information of the display data in response to the display data change event. In this case, the display data output state change processing module 1313 may apply an output state of display data on a stage-by-stage basis based on a method. For example, if color information of display data is changed, the display data output state change processing module 1313 may decrease an RGB value on a stage-by-stage basis. Also, the display data output state change processing module 1313 may restore an output state of changed display data. For example, in a state where an output state of display data of a specified region is changed, if a user input is generated on the specified region or if display data corresponding to the specified region are changed, the display data output state change processing module 1313 may restore an output state of display data of the corresponding region.

According to various embodiments of the present disclosure, if a display data processing function state is set to a turn-on state, the screen change monitoring module 1310 may activate monitoring of the display buffer 1370. For example, the screen change monitoring module 1310 may send a display data processing function state turn-on event to the display buffer management module 1330 to monitor the display buffer 1370. In this regard, the electronic device may include a function setting application which may set a display data processing function state. The function setting application may provide a user interface (UI) to allow a user to select whether to use a function.

The display buffer management module 1330 may monitor the display buffer 1370 and may correct display data stored in the display buffer 1370. For example, the display buffer management module 1330 may check whether display data stored in the display buffer 1370 is changed and may correct the corresponding display data based on performance of a function of the display data output state change processing module 1313. The display buffer management module 1330 may include a display buffer monitoring module 1331 and a display buffer correction module 1333.

In a state where the monitoring of the display buffer 1370 is activated, the display buffer monitoring module 1331 may verify a change of display data stored in the display buffer 1370 upon occurrence of a specific event (e.g., an event preset to output display data on a screen (hereinafter referred to as a “screen output event”)) or at intervals of a specific time. According to an embodiment of the present disclosure, the display buffer monitoring module 1331 may measure a degree to which display data is changed. If the degree to which the display data is changed during a specific time is less than a specific value, the display buffer monitoring module 1331 may send a display data change event to the screen change monitoring module 1310.

According to various embodiments of the present disclosure, the display buffer monitoring module 1331 may monitor the display buffer 1370 for each region of a specific size on a screen. For example, the display buffer monitoring module 1331 may classify a screen into a plurality of regions (hereinafter referred to as a “microcell”), each of which respectively has a specific length in the direction of a horizontal axis (or an x-axis) and in the direction of a vertical axis (e.g., a y-axis). Also, the display buffer monitoring module 1331 may determine whether a display data corresponding to a corresponding microcell is changed for each microcell.

In this regard, the display buffer monitoring module 1331 may monitor the display buffer 1370 by comparing a display buffer (e.g., a first display buffer 1371) of a previously output frame with a display buffer (e.g., a second display buffer 1373) of a subsequently output frame using frames configuring a screen. For example, the display buffer monitoring module 1331 may obtain a result value by calculating first display data stored in the first display buffer 1371, corresponding to a microcell which is a monitored object, and second display data stored in the second display buffer 1373, corresponding to the microcell, for each bit using a logic operator (e.g., an XOR operator). In this case, the display buffer monitoring module 1331 may determine a degree, to which display data corresponding to the microcell is changed, based on the result value.

The display buffer correction module 1333 may correct display data stored in the display buffer 1370. For example, the display buffer correction module 1333 may correct display data in connection with changing color information of the display data, blurring the display data, or changing luminance information of the display data. According to various embodiments of the present disclosure, a least one of the display data output state change processing module 1313 or the display buffer correction module 1333 may perform the same or similar function to that of a display data conversion module 133 of FIG. 1.

The graphic controller 1350 may be a hardware control module which outputs display data on a screen and may perform the same or similar function to that of at least one of a display controller 220 or a panel controller 230 of FIG. 2. The display buffer 1370 may store display data to be output on a screen.

FIG. 14 is a screen illustrating a method for changing display data applied for each region based on an embodiment of the present disclosure.

If a specific application (e.g., a document composition application) is used, in an electronic device (e.g., an electronic device 200 of FIG. 2), a screen change may not occur on a specific region during a specific time due to the nature of the specific application. For example, referring to FIG. 14, if the document composition application is used, in the electronic device, a screen change may not occur almost on a menu region 1411 of a screen upper portion and a state display region 1413 of a screen lower portion. Also, a burn-in phenomenon may occur on a region, such as the menu region 1411 and the state display region 1413, where a screen change does not occur during a specific time.

To prevent the above-mentioned burn-in phenomenon, the electronic device may change display data output on a screen region where a screen change does not occur during a specific time. In this case, the electronic device may classify a screen into a plurality of microcells 1431, each of which respectively has a specific length in the direction of a horizontal axis (or an x-axis) and the direction of a vertical axis (or a y-axis). For example, the electronic device may classify the screen by specifying a size of each of the microcells 1431 in the direction of the horizontal axis and the direction of the vertical axis, each of which is every 32 pixels.

According to various embodiments of the present disclosure, in operation 1433, the electronic device may change display data, classified for each microcell 1431, on a stage-by-stage basis. In FIG. 14, an embodiment of the present disclosure is exemplified as a screen on which luminance information of display data corresponding to a specific microcell is changed on a stage-by-stage basis because a screen of the specific microcell is not changed during a specific time (e.g., three minutes). For example, the electronic device may verify a screen change of the specific microcell at intervals of a specific time. If a change does not occur on a screen, the electronic device may change luminance information of display data corresponding to the specific microcell such that brightness of the display data to become darker and darker to be 90%, 80%, 70%, 60%, and 50% on a stage-by-stage basis.

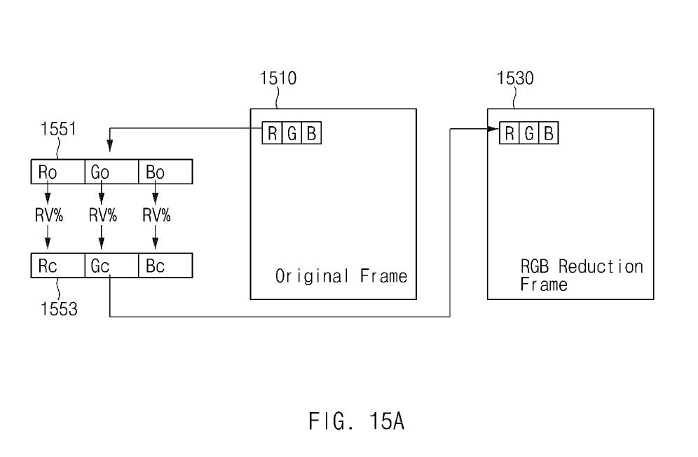

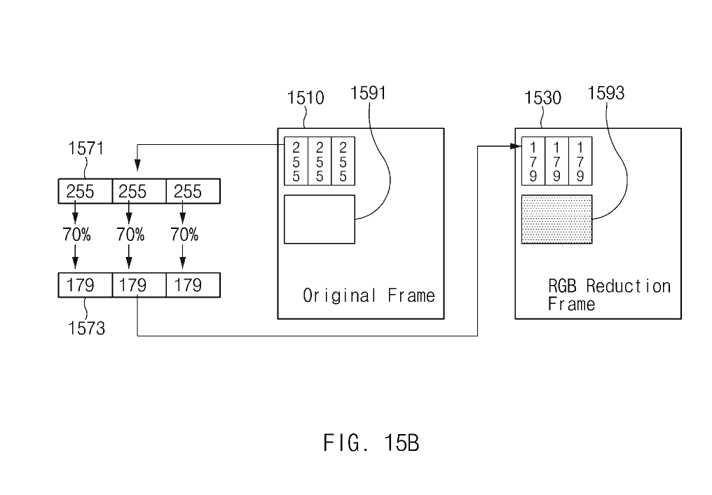

FIG. 15A is a drawing illustrating a color adjustment method among methods for changing display data based on an embodiment of the present disclosure.

Referring to FIG. 15A, an electronic device (e.g., an electronic device 200 of FIG. 2) may change color information of display data stored in a display buffer 1510 of a changed frame and may store the changed display data in a display buffer 1530 of an output frame. In this case, when restoring display data, the electronic device may refer to the display buffer 1510 of the changed frame. According to various embodiments of the present disclosure, the electronic device may store the changed display data in the display buffer 1510 of the changed frame without separately generating the display buffer 1530 of the output frame.

According to various embodiments of the present disclosure, the electronic device may correct a color of display data on a stage-by-stage basis. The electronic device may reduce an RGB value of display data classified for each microcell at intervals of a specific time at a specific rate (e.g., a reduction value (RV) %) on a stage-by-stage basis. For example, the electronic device may reduce display data 1551 corresponding to a specific microcell at a specific rate in the display buffer 1510 of the changed frame. Also, the electronic device may store display data 1553 reduced at the specific rate in the display buffer 1530 of the output frame.

FIG. 15B is a screen illustrating a result of applying a color adjustment method based on an embodiment of the present disclosure.

Referring to FIG. 15B, an electronic device may reduce display data 1571 corresponding to a specific microcell at a specific rate in a display buffer 1510 of a changed frame. In FIG. 15B, an embodiment of the present disclosure is exemplified as the electronic device may obtain display data 1573 which has 179, 179, and 179 as R, G, and B values by reducing the display data 1571, which has 255, 255, and 255 as R, G, and B values, to 70%. Also, the electronic device may store the obtained display data 1573 in a display buffer 1530 of an output frame. As shown in FIG. 15B, the electronic device may adjust a color of display data 1591, expressed with white, at a specific rate to become darker and darker on a stage-by-stage basis and may output display data 1593 expressed with gray through the above-mentioned process, thus preventing a burn-in phenomenon.

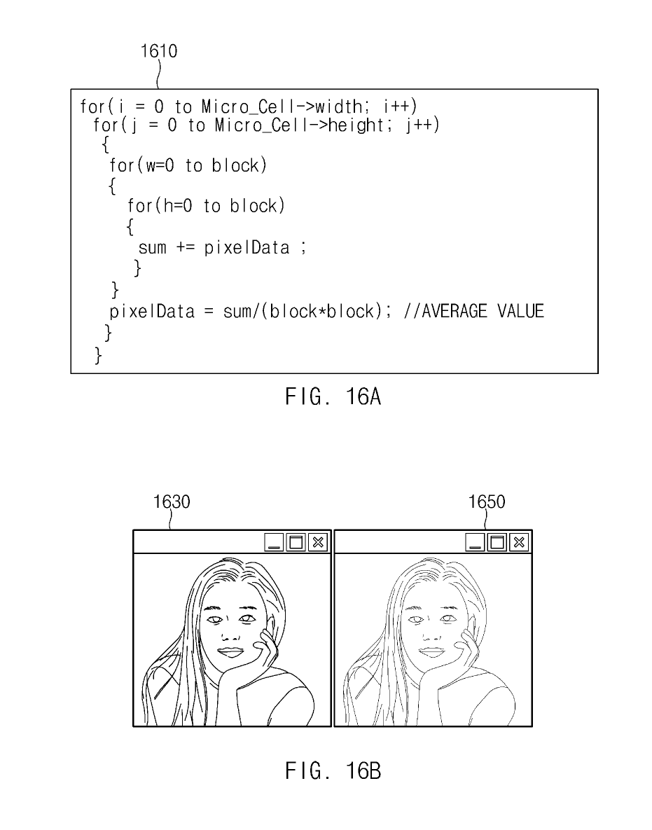

FIG. 16A is a drawing illustrating a blurring method among methods for changing display data based on an embodiment of the present disclosure. FIG. 16B is a screen illustrating a result of applying a blurring method based on an embodiment of the present disclosure.

Referring to FIGS. 16A and 16B, an electronic device (e.g., an electronic device 200 of FIG. 2) may blur display data classified for each microcell. For example, the electronic device may blur display data output on a region where a screen change does not occur during a specific time to be turbidly output on a screen.

As shown in FIG. 16A, the electronic device may blur display data by selecting a block at a specific size on a microcell and designating color information of each of the display data included in the block as a color average value of the display data on a block-by-block basis. Alternatively, the electronic device may blur display data by designating color information of specific display data (e.g., display data located in the center) among display data included in the block as the color average value of the display data on a block-by-block basis.

According to various embodiments of the present disclosure, the electronic device may select a size of the block to be larger on a stage-by-stage basis. The electronic device may select a size of the block to become longer and longer in the direction of a horizontal axis (or an x-axis) and the direction of a vertical axis (or a y-axis) on a stage-by-stage basis. Therefore, the electronic device may increase a blurring level of display data on a stage-by-stage basis at intervals of a specific time. For example, the electronic device may increase a size of the block to 2, 4, 8, 16, and 32 pixels at intervals of a specific time in the direction of the horizontal axis and the direction of the vertical axis, respectively.

As shown in FIG. 16B, the electronic device may blur display data of a changed screen 1630 and may output an output screen 1650.

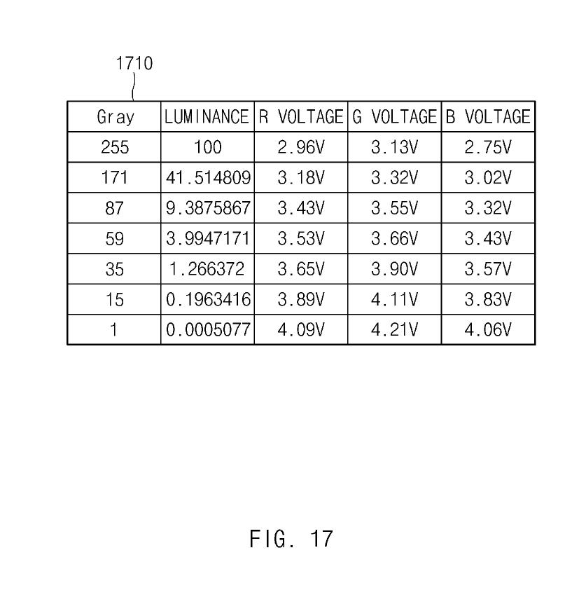

FIG. 17 is a drawing illustrating a luminance adjustment method among methods for changing display data based on an embodiment of the present disclosure.

According to various embodiments of the present disclosure, an electronic device (e.g., an electronic device 200 of FIG. 2) may change luminance information of display data classified for each microcell. The electronic device may change luminance information of display data to be similar to a color adjustment method. According to an embodiment of the present disclosure, the electronic device may converts color information of display data expressed with an RGB value into a YUV type. The YUV type may express display data using luminance information Y and chrominance information U and V of the display data. In this case, the electronic device may change the luminance information at intervals of a specific time on a stage-by-stage basis.

According to various embodiments of the present disclosure, the electronic device may change luminance by adjusting voltage for color information of display data, rather than adjusting brightness by changing luminance information of display data classified for each microcell. Referring to FIG. 17, the electronic device may set voltage for color information of display data based on Table 1710 for luminance and an RGB voltage corresponding to a gray level and may adjust luminance. For example, the electronic device may match a value, obtained by multiplying a reduction value (RV) by a value in which a normal gray value is subtracted from a gray value (e.g., 256), with a gray value indicated in Table 1710. The electronic device may set an RGB voltage value based on matching the values and may adjust luminance.

The scope and spirit of the present disclosure may not be limited thereto. For example, the electronic device may apply various methods in which an output state of display data is changed. For example, the electronic device may change an output state of display data by adjusting a contrast ratio or a gamma value, and the like.

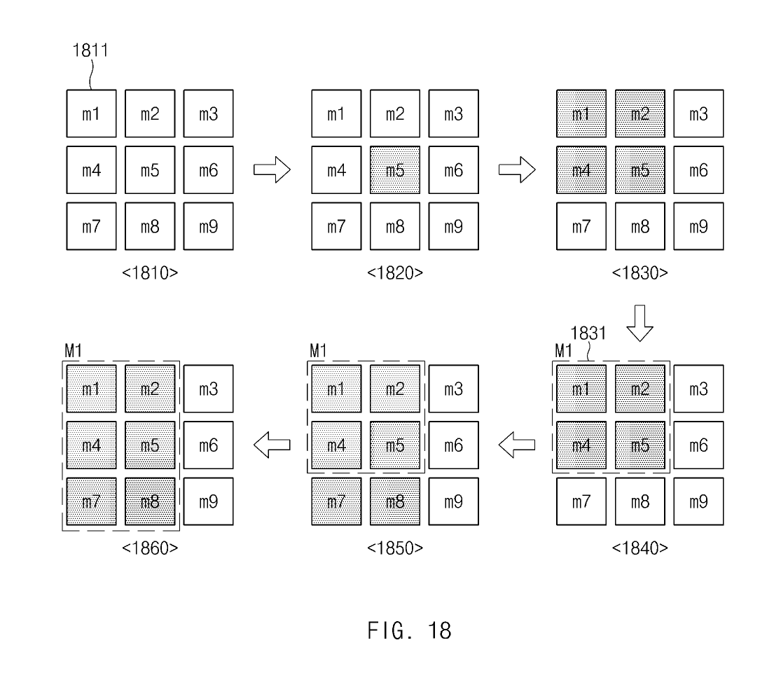

FIG. 18 is a screen illustrating a process of merging regions to which a method for changing display data is applied based on an embodiment of the present disclosure.

Referring to FIG. 18, in state 1810, an electronic device (e.g., an electronic device 200 of FIG. 2) may classify a screen into a plurality of microcells 1811, each of which respectively has a specific length in the direction of a horizontal axis (or an x-axis) and the direction of a vertical direction (or a y-axis). In this case, the electronic device may apply a method for changing display data for each microcell 1811. For example, if a screen of a specific microcell is not changed during a specific time, the electronic device may change an output state of display data corresponding to the specific microcell.

According to various embodiments of the present disclosure, the electronic device may verify a screen change for each microcell at intervals of a specific time in connection with changing display data and may apply a method for changing display data on a stage-by-stage basis. For example, if a screen of a specific microcell is not changed during a specific time, the electronic device may change an output state of display data corresponding to the specific microcell. Also, after changing the output state of the display data, if the screen of the specific microcell is not changed once again during the specific time, the electronic device may change the output state of the display data, corresponding to the specific microcell, to a level corresponding to a next stage. Thereafter, the electronic device may increase a level to become higher and higher until a change stage of an output state of display data reaches the last stage and may change the output state of the display data.

In state 1820, the electronic device may change an output state of display data corresponding to a specific microcell (e.g., a microcell m5) on a stage-by-stage basis. Therefore, a change stage of the corresponding display data may reach the last stage. In this case, the electronic device may verify a change stage of display data corresponding to microcells of regions adjacent to the specific microcell.

In state 1830, the electronic device may verify cells (e.g., a microcell m1, a microcell m2, and a microcell 4), in which a change stage of display data reaches the last stage, among the microcells of the regions adjacent to the specific microcell. In this case, in state 1840, the electronic device may merge the specific microcell and the cells in which the change stage reaches the last stage into a macrocell (e.g., a macrocell M1 1831) of a larger region by grouping the specific microcell and the cells in which the change stage reaches the last stage into one.

According to various embodiments of the present disclosure, in applying a method for changing display data, basically, the electronic device may verify a screen change for each microcell. However, as described above, if there is a microcell into which cells where it is difficult to no longer change an output state because a change state reaches the last stage are merged, the electronic device may regard the macrocell as a microcell, may verify a screen change, and may newly apply a method for changing display data. For example, in state 1840, the electronic device may group display data corresponding to the microcell m1, the microcell m2, the microcell m4, and the microcell m5 merged into the macrocell M1 1831 and may blur the grouped display data on a stage-by-stage basis at intervals of a specific time.

In state 1850, after blurring the macrocell M1 1831, if there are cells (e.g., a microcell m7 and a microcell m8), in which a change stage reaches the last stage, among microcells or macrocells located on regions adjacent to the macrocell M1 1831, the electronic device may merge (or expand) the macrocell M1 1831 and the cells, in which the change stage reaches the last stage, into one. In this case, in state 1860, the electronic device may blur display data, corresponding to the merged (or expanded) macrocell M1, on a stage-by-stage basis at intervals of a specific time.

According to various embodiments of the present disclosure, if a user input or a screen change occurs on a microcell or a macrocell in which an output state of display data is changed, the electronic device may restore display data corresponding to the corresponding cell. For example, although a change stage of display data corresponding to a specific microcell reaches any stage, the electronic device may restore an output state of the display data to an original output state and may output a normal screen. Also, if a user input or a screen change occurs on a specific microcell included in a specific macrocell, the electronic device may ungroup the specific microcell grouped into the specific macrocell and may restore display data corresponding to the specific microcell.

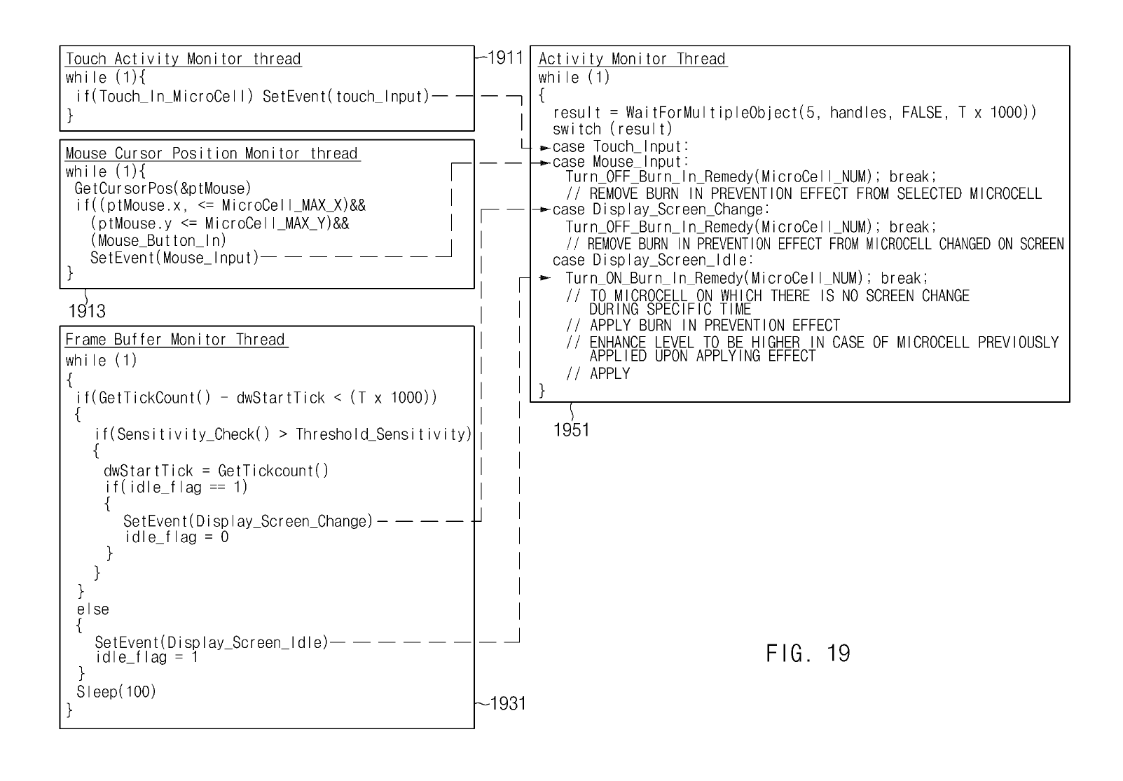

FIG. 19 is a drawing illustrating a module associated with changing display data based on an embodiment of the present disclosure.

Referring to FIG. 19, a screen change monitoring module (e.g., a screen change monitoring module 1310 of FIG. 13) may include a touch input monitoring thread 1911 and a mouse cursor position monitoring thread 1913. Also, a display buffer monitoring module (e.g., a display buffer monitoring module 1311 of FIG. 13) may include a display buffer monitoring thread 1931.

According to various embodiments of the present disclosure, if an input associated with a monitored object while a monitoring function is performed is received in each of the above-mentioned threads or if satisfying a condition, each of the above-mentioned threads may register a callback function to send a related event to the screen change monitoring module. If the calling function is called, a related event, for example, a user input receiving event or a display data change event, and the like may be sent to the screen change monitoring module. Also, the screen change monitoring module may perform a corresponding function through a display data output state change processing module (e.g., a display data output state change processing module 1313) including a thread 1951 in which a processing routine of the related event is implemented.

In FIG. 19, an embodiment of the present disclosure is exemplified as modules based on a specific platform, for example, a windows OS. Therefore, a method for implementing modules configuring the electronic device based on an embodiment of the present disclosure may not be limited thereto. For example, the method for implementing the modules may be modified and applied in various ways based on a platform supported by the electronic device.

As described above, according to various embodiments of the present disclosure, the processor may be configured to monitor a change state of a designated screen area. If a degree to which display data output on the screen area during a designated time is change is less than a designated value, the processor may be configured to change the display data.

According to various embodiments of the present disclosure, the processor may be configured to logically operating previously outputted display data and subsequently outputted display data for each bit and to determine a degree, to which the display data is changed, based on the logically operated result.

According to various embodiments of the present disclosure, if the degree to which the display data is changed is less than the designated value, the processor may be configured to change the display data by at least one of changing color information of the display data, blurring the display data, and changing luminance information of the display data.

According to various embodiments of the present disclosure, if a touch input occurs or a mouse cursor is located on the screen area, the processor may be configured to restore the display data.

According to various embodiments of the present disclosure, the processor may be configured to reduce the color information of the display data at a specific rate on a stage-by-stage basis at intervals of a specific time, to increase a blurring level of the display data at a specific rate on a stage-by-stage basis at intervals of a specific time, or to reduce the luminance information of the display data at a specific rate on a stage-by-stage basis at intervals of a specific time.

According to various embodiments of the present disclosure, if a change stage of the display data is the last stage, the processor may be configured to change merge areas, where a change stage of display data is the last stage, among areas adjacent to the screen area with the screen area and to change display data corresponding to the merged area.

According to various embodiments of the present disclosure, if a touch input occurs or a mouse cursor is located on the screen area, the processor may be configured to demerge the screen area from the merged area and to restore display data corresponding to the screen area.

According to various embodiments of the present disclosure, the electronic device may further include a panel controller configured to process the display data or an image signal into which the display data is converted. The panel controller may be configured to change the display data rather than the processor.

According to various embodiments of the present disclosure, the panel controller may receive an output state change event of the display data from a processor or a display controller, included in the electronic device or an external electronic device connected with the electronic device through wired and wireless communication, through a communication interface or to receive an output state change event of the display data from the processor or the display controller through a GPIO.

According to various embodiments of the present disclosure, the panel controller may obtain the display data from a storing medium, included in the electronic device or the external electronic device, in response to reception of an output state change event of the display data.

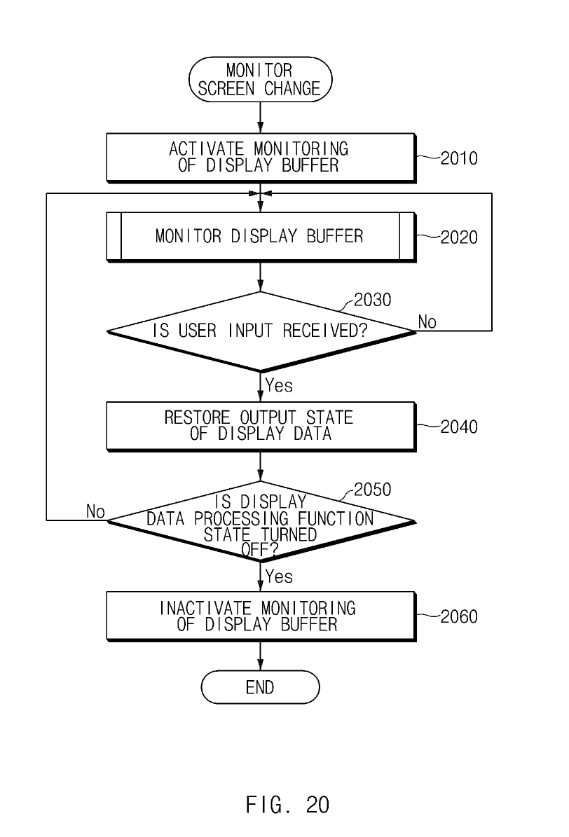

FIG. 20 is a flowchart illustrating an electronic device operating method associated with changing display data based on an embodiment of the present disclosure.

Referring to FIG. 20, if a display data processing function state is set to a turn-on state, an electronic device (e.g., an electronic device 200 of FIG. 2) may monitor whether a change of all or part of a screen occurs. In operation 2010, the electronic device may activate monitoring of a display buffer. For example, the electronic device may send an event to execute a display buffer monitoring thread (e.g., a display buffer monitoring thread 1931 of FIG. 19) included in a display buffer monitoring module (e.g., a display buffer monitoring module 1331 of FIG. 13).

In operation 2020, the electronic device may monitor a display buffer based on a routine implemented in the display buffer monitoring thread. For example, the electronic device may verify a change of display data stored in a display buffer (e.g., a display buffer 1370 of FIG. 13) upon occurrence of a specific event (e.g., a screen output event) or at intervals of a specific time.

In operation 2030, the electronic device may determine whether a user input is received. For example, the electronic device may determine whether a touch input occurs or a position of a mouse cursor is changed. In this regard, the electronic device may execute a touch input monitoring thread (e.g., a touch input monitoring thread 1911 of FIG. 19) and a mouse cursor position monitoring thread (e.g., a mouse cursor position monitoring thread 1913 of FIG. 19) at a time when a display data processing function state is set to a turn-on state or a time when the electronic device is powered-on. In FIG. 20, an embodiment of the present disclosure is exemplified as the operation of determining whether the user input is received is performed after the operation of monitoring the display buffer. However, the scope and spirit of the present disclosure may not be limited thereto. For example, the operation of determining whether the user input is received may be performed before and after or while operations included in an operation of monitoring a screen change are performed.

If the user input is not received, the electronic device may perform operation 2020 to continuously perform monitoring of the display buffer. According to various embodiments of the present disclosure, the operation of monitoring the display buffer and the operation of determining whether the user input is received may be simultaneously performed rather than sequentially performing the operations.

If the user is received, in operation 2040, the electronic device may restore display data. For example, the electronic device may verify a change stage of display data for each microcell. Also, if an output state of display data corresponding to a microcell on which the user input occurs is changed, the electronic device may restore the output state of the display data to an original state. According to an embodiment of the present disclosure, when restoring an output state of display data, the electronic device may refer to a display buffer of a changed frame used in a change of an output state.

In operation 2050, the electronic device may determine whether a display data processing function state is set to a turn-off state. If the display data processing function state is not set to the turn-off state, the electronic device may return to operation 2020 and may continuously perform monitoring of the display buffer. According to various embodiments of the present disclosure, the operation of verifying the display data processing function state may be performed before and after or while operations included in an operation of monitoring a screen change are performed to be similar to the operation of determining whether the user input is received. If the display data processing function state is changed to the turn-off state, in operation 2060, the electronic device may inactivate the monitoring of the display buffer.

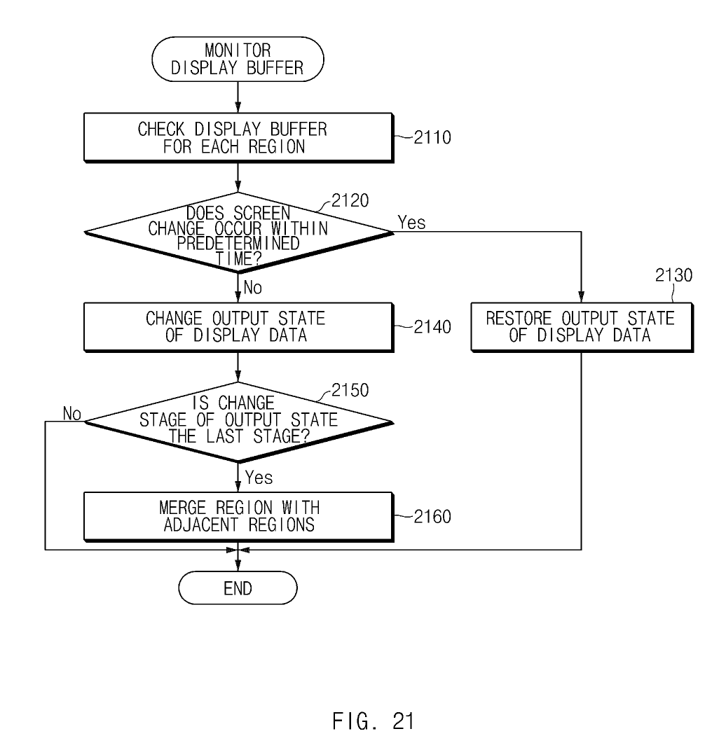

FIG. 21 is a flowchart illustrating an electronic device operating method associated with monitoring a display buffer based on an embodiment of the present disclosure.

Referring to FIG. 21, if activating monitoring of a display buffer, in operation 2110, an electronic device (e.g., an electronic device 200 of FIG. 2) may check the display buffer (e.g., a display buffer 1370 of FIG. 13) for each region. For example, the electronic device may classify a screen into a plurality of regions (e.g., microcells 1811 of FIG. 18), each of which respectively has a specific length in the direction of a horizontal axis (or an x-axis) or the direction of a vertical axis (or a y-axis) and may check the display buffer for each region. The electronic device may compare a display buffer of a previously output frame with a display buffer of a subsequently output frame for each region. For example, the electronic device may logically operate the display buffers for each bit and may determine whether display data is changed for each region. According to an embodiment of the present disclosure, the electronic device may measure a degree to which a display data is changed for each region. Only if the degree to which the display data is changed is less than a specific value, the electronic device may determine that a screen of the region is not changed.

In operation 2120, the electronic device may determine whether the screen of the region is changed during a specific time. If determining that the screen is changed, in operation 2130, the electronic device may restore an output state of display data. For example, if an output state of display data corresponding to the region is changed, the electronic device may restore the output state of the display data to an original state.

If determining that the screen is not changed, in operation 2140, the electronic device may change an output state of display data. According to an embodiment of the present disclosure, the electronic device may change the output state of the display data corresponding to the region on a stage-by-stage basis. For example, in operation 2150, the electronic device may determine a change stage of an output state of display data. If the change stage of the output state is not the last stage, the electronic device may change the change stage of the output state to a next stage. Also, if the change stage of the output state is the last stage, in operation 2160, the electronic device may verify a change stage of an output state of each of regions adjacent to the region and may merge the region with regions, where a change stage of an output state is the last stage, among the adjacent regions. According to various embodiments of the present disclosure, when checking the display buffer for each region in operation 2110, the electronic device may regard the regions (e.g., a macrocell M1 1831 of FIG. 18) merged in operation 2160 as one region and may process the regions.

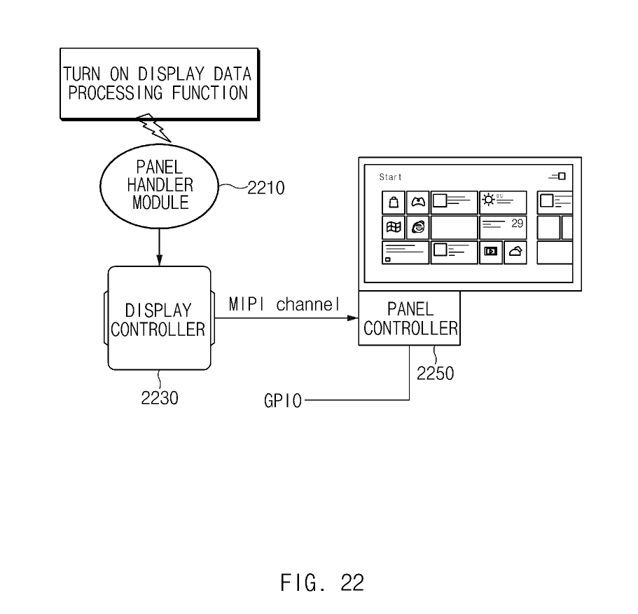

FIG. 22 is a drawing illustrating a screen associated with changing display data based on an embodiment of the present disclosure;

Referring to FIG. 22, if a display data processing function state is set to a turn-on state, an electronic device (e.g., an electronic device 200 of FIG. 2) may monitor a screen change. For example, the electronic device may detect an event (e.g., a user input receiving event or a display data change event), associated with a screen change, through a panel handler module 2210. Also, the electronic device may change display data corresponding to the event associated with the screen change. For example, the electronic device may send a command to change display data to a panel controller 2250 to change the display data.

According to various embodiments of the present disclosure, the electronic device may send the command to change the display data, for example, a mobile industry processor interface (MIPI) command through a display controller 2230. For example, the electronic device may send the command to change the display data through a communication channel (e.g., an MIPI channel) connected between the display controller 2230 and the panel controller 2250. Also, the electronic device may directly control a general purpose input/output (GPIO) signal through the panel handler module 2210 and may send the command to change the display data to the panel controller 2250.

According to various embodiments of the present disclosure, the electronic device may change display data based on the panel controller 2250. According to an embodiment of the present disclosure, if the display data processing function state is set to the turn-on state, the electronic device may send a related event (or a command corresponding to the related event) to the panel controller 2250 through the panel handler module 2210 to monitor a screen change. If receiving the event (or the command corresponding to the event), the panel controller 2250 may monitor a screen change. For example, the panel controller 2250 may monitor a display buffer (e.g., a display buffer 1370 of FIG. 13). According to an embodiment of the present disclosure, the display buffer may be a storing medium which is included in the panel controller 2250 or connected with the panel controller 2250 and may store display buffer.

If at least part of a screen is not changed during a specific time, for example, if display data corresponding to at least part of the screen is not changed, the panel controller 2250 may change the display data. According to an embodiment of the present disclosure, the panel controller 2250 may adjust a color of the display data, may blur the display data, or may adjust luminance of the display data.

According to various embodiments of the present disclosure, a method for processing display data in an electronic device may include monitoring a change state of a designated screen area, determining a degree to which a display data output on the screen area is changed, and changing the display data if the degree to which the display data is changed is less than a designated value.

According to various embodiments of the present disclosure, the determining of the degree to which the display data is changed may include logically operating previously outputted display data and subsequently outputted display data for each bit and determining the degree, to which the display data is changed, based on the logically operated result.

According to various embodiments of the present disclosure, the changing of the display data may include at least one of changing color information of the display data, blurring the display data, or changing luminance information of the display data.

According to various embodiments of the present disclosure, the changing of the display data may include at least one of reducing the color information of the display data at a specific rate on a stage-by-stage basis at intervals of a specific time, increasing a blurring level of the display data at a specific rate on a stage-by-stage basis at intervals of a specific time, or reducing the luminance information of the display data at a specific rate on a stage-by-stage basis at intervals of a specific time.

According to various embodiments of the present disclosure, the method may further include restoring the display data, if a touch input occurs or a mouse cursor is located on the screen area.

According to various embodiments of the present disclosure, the method may further include merging areas, where a change stage of each of display data is the last stage, among areas adjacent to the screen area with the screen area, if a change stage of the display data is the last stage and changing display data corresponding to the merged area.

According to various embodiments of the present disclosure, the method may further include demerging the screen area from the merged area, if a touch input occurs or a mouse cursor is located on the screen area and restoring display data corresponding to the screen area.

According to various embodiments of the present disclosure, the changing of the display data may further include an operation performed by a panel controller which processes the display data or an image signal into which the display data is converted.

According to various embodiments of the present disclosure, the operation performed by the panel controller may include receiving an output state change event of the display data from a processor or a display controller, included in the electronic device or an external electronic device connected with the electronic device through wired and wireless communication, through a communication interface or receiving an output state change event of the display data from the processor or the display controller through a GPIO.

According to various embodiments of the present disclosure, the operation performed by the panel controller may further include collecting the display data from a storing medium, included in the electronic device or the external electronic device, in response to reception of a change event of an output state of the display data.

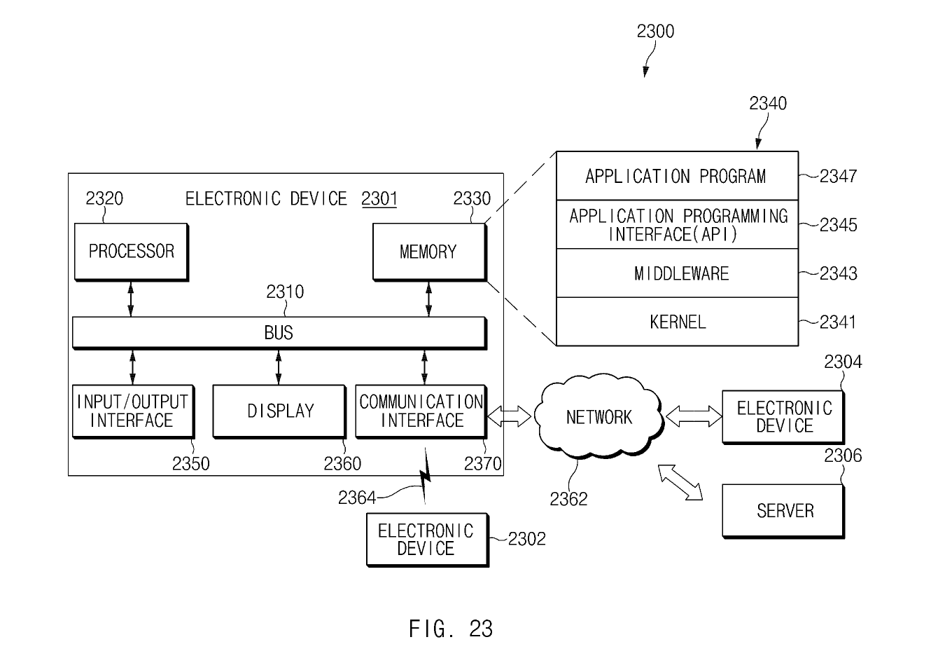

FIG. 23 is a block diagram illustrating a configuration of an electronic device 2301 in a network environment 2300 according to various embodiments of the present disclosure. A description will be given of the electronic device 2301 in a network environment 2300 with reference to FIG. 23 based on various embodiments of the present disclosure. The electronic device 2301 may include a bus 2310, a processor 2320, a memory 2330, an input and output interface 2350, a display 2360, and a communication interface 2370. In various embodiments of the present disclosure, at least one of the components may be omitted from the electronic device 2301, and other components may be additionally included in the electronic device 2301.

The bus 2310 may be, for example, a circuit which connects the components 2320 to 2370 with each other and transmits communication (e.g., a control message and/or data) between the components.

The processor 2320 may include one or more of a central processing unit (CPU), an application processor (AP), or a communication processor (CP). For example, the processor 2320 may perform calculation or data processing about control and/or communication of at least another of the components of the electronic device 2301.

The memory 2330 may include a volatile and/or non-volatile memory. The memory 2330 may store, for example, instructions or data associated with at least another of the components of the electronic device 2301. According to an embodiment of the present disclosure, the memory 2330 may software and/or a program 2340. The program 2340 may include, for example, a kernel 2341, a middleware 2343, an application programming interface (API) 2345, and/or an application program (or an “application”) 2347, and the like. At least part of the kernel 2341, the middleware 2343, or the API 2345 may be referred to as an operating system (OS).

The kernel 2341 may control or manage, for example, system resources (e.g., the bus 2310, the processor 2320, or the memory 2330, and the like) used to execute an operation or function implemented in the other programs (e.g., the middleware 2343, the API 2345, or the application program 2347). Also, as the middleware 2343, the API 2345, or the application program 2347 accesses a separate component of the electronic device 2301, the kernel 2341 may provide an interface which may control or manage system resources.

The middleware 2343 may play a role as, for example, a go-between such that the API 2345 or the application program 2347 communicates with the kernel 2341 to communicate data.

Also, the middleware 2343 may process one or more work requests received from the application program 2347 in the order of priorities. For example, the middleware 2343 may provide priorities which may use system resources (the bus 2310, the processor 2320, or the memory 2330, and the like) of the electronic device 2301 to at least one of the application program 2347. For example, the middleware 2343 may perform scheduling or load balancing for the one or more work requests by processing the one or more work requests in the order of the priorities provided to the at least one of the application program 2347.

The API 2345 may be, for example, an interface in which the application program 2347 controls a function provided from the kernel 2341 or the middleware 2343. For example, the API 2345 may include at least one interface or function (e.g., instruction) for file control, window control, image processing, or text control, and the like.

The input and output interface 2350 may play a role as, for example, an interface which may transmit instructions or data input from a user or another external device to another component (or other components) of the electronic device 2301. Also, input and output interface 2350 may output instructions or data received from another component (or other components) of the electronic device 2301 to the user or the other external device.

The display 2360 may include, for example, a liquid crystal display (LCD), a light emitting diode (LED) display, an organic LED (OLED) display, a microelectromechanical systems (MEMS) display, or an electronic paper display. The display 2360 may display, for example, a variety of content (e.g., text, images, videos, icons, or symbols, and the like) to the user. The display 2360 may include a touch screen, and may receive, for example, touch, gesture, proximity, or a hovering input using an electronic pen or part of a body of the user.

The communication interface 2370 may establish communication between, for example, the electronic device 2301 and an external device (e.g., a first external electronic device 2302, a second external electronic device 2304, or a server 2306). For example, the communication interface 2370 may connect to a network 2362 through wireless communication or wired communication and may communicate with the external device (e.g., the second external electronic device 2304 or the server 2306).

The wireless communication may use, for example, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like as a cellular communication protocol. Also, the wireless communication may include, for example, local-area communication 2364. The local-area communication 2364 may include, for example, at least one of wireless-fidelity (Wi-Fi) communication, Bluetooth (BT) communication, near field communication (NFC), or global navigation satellite system (GNSS) communication, and the like. The GNSS may include, for example, at least one of a global positioning system (GPS), a Glonass, a Beidou navigation satellite system (hereinafter referred to as a “Beidou”), or a Galileo (i.e., the European global satellite-based navigation system) according to an available area or a bandwidth, and the like. Hereinafter, the “GPS” used herein may be interchangeably with the “GNSS”. The wired communication may include at least one of, for example, universal serial bus (USB) communication, high definition multimedia interface (HDMI) communication, recommended standard 232 (RS-232) communication, or plain old telephone service (POTS) communication, and the like. The network 2362 may include a telecommunications network, for example, at least one of a computer network (e.g., a local area network (LAN) or a wide area network (WAN)), the Internet, or a telephone network.

Each of the first and second external electronic devices 2302 and 2304 may be the same as or different device from the electronic device 2301. According to an embodiment of the present disclosure, the server 2306 may include a group of one or more servers. According to various embodiments of the present disclosure, all or some of operations executed in the electronic device 2301 may be executed in another electronic device or a plurality of electronic devices (e.g., the first and second external electronic devices 2302 and 2304 or the server 2306). According to an embodiment of the present disclosure, if the electronic device 2301 should perform any function or service automatically or according to a request, it may request another device (e.g., the first and second external electronic devices 2302 and 2304 or the server 2306) to perform at least part of the function or service, rather than executing the function or service for itself or in addition to the function or service. The other electronic device (e.g., the first and second external electronic devices 2302 and 2304 or the server 2306) may execute the requested function or the added function and may transmit the executed result to the electronic device 2301. The electronic device 2301 may process the received result without change or additionally and may provide the requested function or service. For this purpose, for example, cloud computing technologies, distributed computing technologies, or client-server computing technologies may be used.

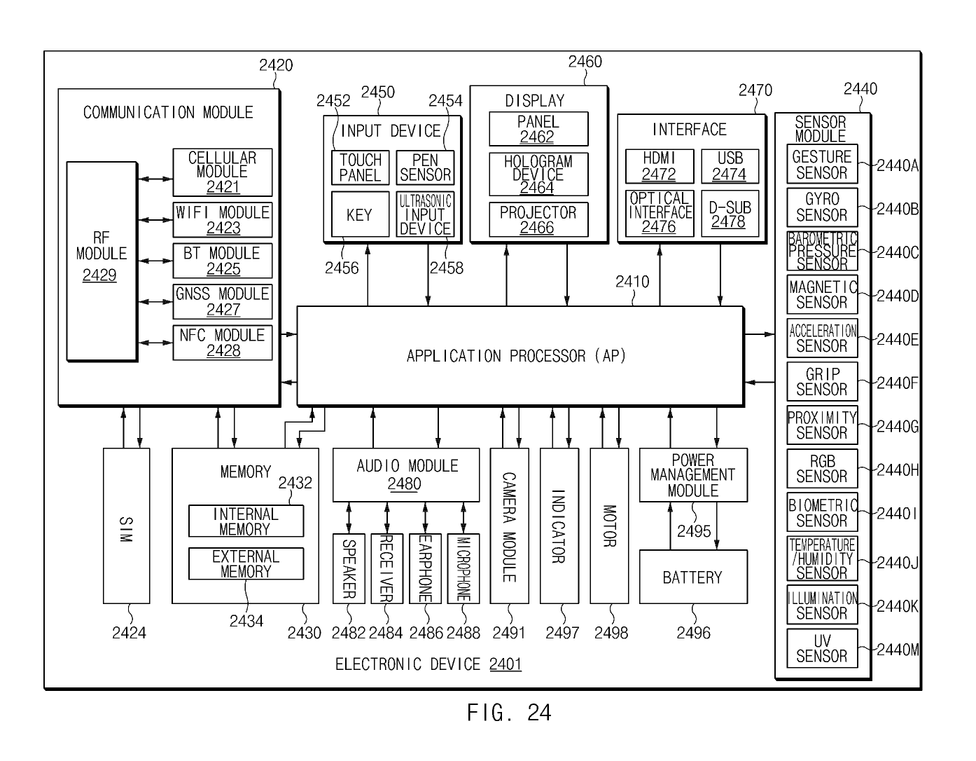

FIG. 24 is a block diagram illustrating a configuration of an electronic device 2401 according to various embodiments of the present disclosure. The electronic device 2401 may include, for example, all or part of an electronic device 2301 shown in FIG. 23. The electronic device 2401 may include one or more processors 2410 (e.g., application processors (APs)), a communication module 2420, a subscriber identification module (SIM) 2424, a memory 2430, a sensor module 2440, an input device 2450, a display 2460, an interface 2470, an audio module 2480, a camera module 2491, a power management module 2495, a battery 2496, an indicator 2497, and a motor 2498.

The processor 2410 may drive, for example, an operating system (OS) or an application program to control a plurality of hardware or software components connected thereto and may process and compute a variety of data. The processor 2410 may be implemented with, for example, a system on chip (SoC). According to an embodiment of the present disclosure, the processor 2410 may further include a graphic processing unit (GPU) (not shown) and/or an image signal processor (not shown). The processor 2410 may include at least some (e.g., a cellular module 2421) of the components shown in FIG. 24. The processor 2410 may load instructions or data received from at least one of other components (e.g., a non-volatile memory) to a volatile memory to process the data and may store various data in a non-volatile memory.

The communication module 2420 may have the same or similar configuration to that of a communication interface 2370 of FIG. 23. The communication module 2420 may include, for example, the cellular module 2421, a wireless-fidelity (Wi-Fi) module 2423, a Bluetooth (BT) module 2425, a global navigation satellite system (GNSS) module 2427 (e.g., a GPS module, a Glonass module, a Beidou module, or a Galileo module), a near field communication (NFC) module 2428, and a radio frequency (RF) module 2429.

The cellular module 2421 may provide, for example, a voice call service, a video call service, a text message service, or an Internet service, and the like through a communication network. According to an embodiment of the present disclosure, the cellular module 2421 may identify and authenticate the electronic device 2401 in a communication network using a SIM 2424 (e.g., a SIM card). According to an embodiment of the present disclosure, the cellular module 2421 may perform at least part of functions which may be provided by the processor 2410. According to an embodiment of the present disclosure, the cellular module 2421 may include a communication processor (CP).

The Wi-Fi module 2423, the BT module 2425, the GNSS module 2427, or the NFC module 2428 may include, for example, a processor for processing data transmitted and received through the corresponding module. According to various embodiments of the present disclosure, at least some (e.g., two or more) of the cellular module 2421, the Wi-Fi module 2423, the BT module 2425, the GNSS module 2427, or the NFC module 2428 may be included in one integrated chip (IC) or one IC package.

The RF module 2429 may transmit and receive, for example, a communication signal (e.g., an RF signal). Though not shown, the RF module 2429 may include, for example, a transceiver, a power amplifier module (PAM), a frequency filter, or a low noise amplifier (LNA), or an antenna, and the like. According to another embodiment of the present disclosure, at least one of the cellular module 2421, the Wi-Fi module 2423, the BT module 2425, the GNSS module 2427, or the NFC module 2428 may transmit and receive an RF signal through a separate RF module.

The SIM 2424 may include, for example, a card which includes a SIM and/or an embedded SIM. The SIM 2424 may include unique identification information (e.g., an integrated circuit card identifier (ICCID)) or subscriber information (e.g., an international mobile subscriber identity (IMSI)).

The memory 2430 (e.g., a memory 2330 of FIG. 23) may include, for example, an embedded memory 2432 or an external memory 2434. The embedded memory 2432 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 2434 may further include a flash drive, for example, a compact flash (CF), a secure digital (SD), a micro-SD, a mini-SD, an extreme digital (xD), or a memory stick, and the like. The external memory 2434 may functionally and/or physically connect with the electronic device 2401 through various interfaces.

The sensor module 2440 may measure, for example, a physical quantity or may detect an operation state of the electronic device 2401, and may convert the measured or detected information to an electric signal. The sensor module 2440 may include at least one of, for example, a gesture sensor 2440A, a gyro sensor 2440B, a barometric pressure sensor 2440C, a magnetic sensor 2440D, an acceleration sensor 2440E, a grip sensor 2440F, a proximity sensor 2440G, a color sensor 2440H (e.g., red, green, blue (RGB) sensor), a biometric sensor 2440I, a temperature/humidity sensor 2440J, an illumination sensor 2440K, or an ultraviolet (UV) sensor 2440M. Additionally or alternatively, the sensor module 2440 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 940 may further include a control circuit for controlling at least one or more sensors included therein. According to various embodiments of the present disclosure, the electronic device 2401 may further include a processor configured to control the sensor module 2440, as part of the processor 2410 or to be independent of the processor 2410. While the processor 2410 is in a sleep state, the electronic device 2401 may control the sensor module 2440.

The input device 2450 may include, for example, a touch panel 2452, a (digital) pen sensor 2454, a key 2456, or an ultrasonic input unit 2458. The touch panel 2452 may recognize a touch input using at least one of, for example, a capacitive detecting method, a resistive detecting method, an infrared detecting method, or an ultrasonic detecting method. Also, the touch panel 2452 may further include a control circuit. The touch panel 2452 may further include a tactile layer and may provide a tactile reaction to a user.

The (digital) pen sensor 2454 may be, for example, part of a touch panel or may include a separate sheet for recognition. The key 2456 may include, for example, a physical button, an optical key, or a keypad. The ultrasonic input unit 2458 may allow the electronic device 2401 to detect a sound wave using a microphone (e.g., a microphone 2488) and to verify data through an input tool generating an ultrasonic signal.

The display module 2460 (e.g., a display 2360 of FIG. 23) may include a panel 2462, a hologram device 2464, or a projector 2466. The panel 2462 may include the same or similar configuration to that of the display 2360. The panel 2462 may be implemented to be, for example, flexible, transparent, or wearable. The panel 2462 and the touch panel 2452 may be integrated into one module. The hologram device 2464 may show a stereoscopic image in a space using interference of light. The projector 2466 may project light onto a screen to display an image. The screen may be positioned, for example, inside or outside the electronic device 2401. According to an embodiment of the present disclosure, the display 2460 may further include a control circuit for controlling the panel 2462, the hologram device 2464, or the projector 2466.

The interface 2470 may include, for example, a high-definition multimedia interface (HDMI) 2472, a universal serial bus (USB) 2474, an optical interface 2476, or a D-subminiature 2478. The interface 2470 may be included in, for example, a communication interface 2370 shown in FIG. 23. Additionally or alternatively, the interface 2470 may include, for example, a mobile high definition link (MHL) interface, an SD card/multimedia card (MMC) interface, or an infrared data association (IrDA) standard interface.

The audio module 2480 may convert a sound and an electric signal in dual directions. At least part of components of the audio module 2480 may be included in, for example, an input and output interface 2350 shown in FIG. 23. The audio module 2480 may process sound information input or output through, for example, a speaker 2482, a receiver 2484, an earphone 2486, or the microphone 2488, and the like.

The camera module 2491 may be a device which captures a still image and a moving image. According to an embodiment of the present disclosure, the camera module 2491 may include one or more image sensors (not shown) (e.g., a front sensor or a rear sensor), a lens (not shown), an image signal processor (ISP) (not shown), or a flash (not shown) (e.g., an LED or a xenon lamp).

The power management module 2495 may manage, for example, power of the electronic device 2401. According to an embodiment of the present disclosure, though not shown, the power management module 2495 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 2496 and voltage, current, or temperature thereof while the battery 2496 is charged. The battery 2496 may include, for example, a rechargeable battery or a solar battery.

The indicator 2497 may display a specific state of the electronic device 2401 or part (e.g., the processor 2410) thereof, for example, a booting state, a message state, or a charging state, and the like. The motor 2498 may convert an electric signal into mechanical vibration and may generate vibration or a haptic effect, and the like. Though not shown, the electronic device 2401 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a mediaFlo™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

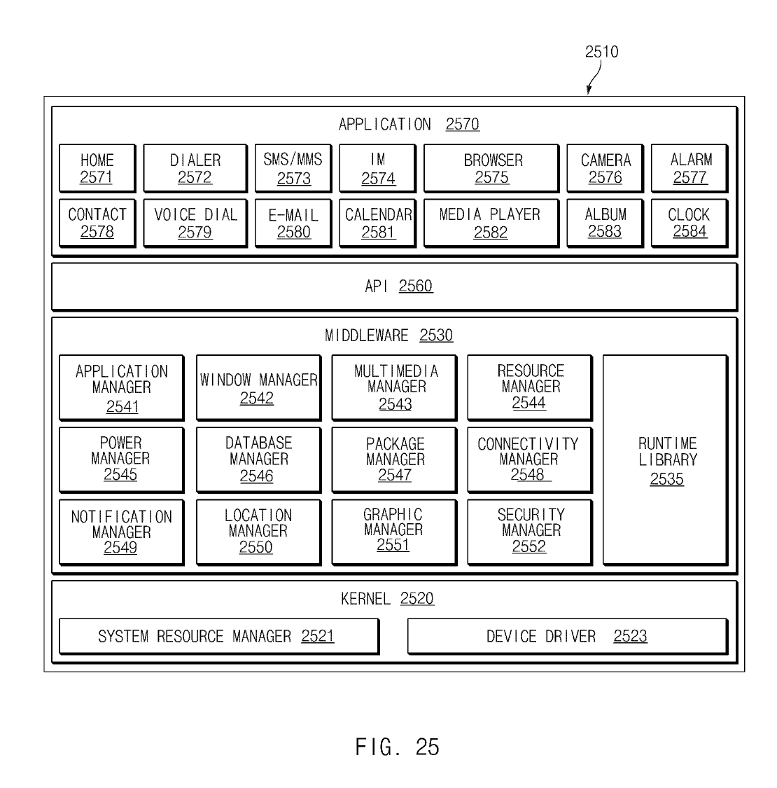

FIG. 25 is a block diagram illustrating a configuration of a program module based on various embodiments of the present disclosure. According to an embodiment of the present disclosure, a program module 2510 (e.g., a program 2340 of FIG. 23) may include an operating system (OS) for controlling resources associated with an electronic device (e.g., an electronic device 2301 of FIG. 23) and/or various applications (e.g., an application program 2347 of FIG. 23) which are executed on the OS. The OS may be, for example, Android, iOS, Windows, Symbian, Tizen, or Bada, and the like.

The program module 2510 may include a kernel 2520, a middleware 2530, an application programming interface (API) 2560, and/or an application 2570. At least part of the program module 2510 may be preloaded on the electronic device, or may be downloaded from an external electronic device (e.g., first and second external electronic devices 2302 and 2304, a server 2306, and the like of FIG. 23).

The kernel 2520 (e.g., a kernel 2341 of FIG. 23) may include, for example, a system resource manager 2521 and/or a device driver 2523. The system resource manager 2521 may control, assign, or collect, and the like system resources. According to an embodiment of the present disclosure, the system resource manager 2521 may include a process management unit, a memory management unit, or a file system management unit, and the like. The device driver 2523 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 2530 (e.g., a middleware 2343 of FIG. 23) may provide, for example, functions the application 2570 needs in common, and may provide various functions to the application 2570 through the API 2560 such that the application 2570 efficiently uses limited system resources in the electronic device. According to an embodiment of the present disclosure, the middleware 2530 (e.g., the middleware 2343) may include at least one of a runtime library 2535, an application manager 2541, a window manager 2542, a multimedia manager 2543, a resource manager 2544, a power manager 2545, a database manager 2546, a package manager 2547, a connectivity manager 2548, a notification manager 2549, a location manager 2550, a graphic manager 2551, or a security manager 2552.

The runtime library 2535 may include, for example, a library module used by a compiler to add a new function through a programming language while the application 2570 is executed. The runtime library 2535 may perform a function about input and output management, memory management, or an arithmetic function.

The application manager 2541 may manage, for example, a life cycle of at least one of the application 2570. The window manager 2542 may manage graphic user interface (GUI) resources used on a screen of the electronic device. The multimedia manager 2543 may ascertain a format necessary for reproducing various media files and may encode or decode a media file using a codec corresponding to the corresponding format. The resource manager 2544 may manage source codes of at least one of the application 2570, and may manage resources of a memory or a storage space, and the like.

The power manager 2545 may act together with, for example, a basic input/output system (BIOS) and the like, may manage a battery or a power source, and may provide power information necessary for an operation of the electronic device. The database manager 2546 may generate, search, or change a database to be used in at least one of the application 2570. The package manager 2547 may manage installation or update of an application distributed by a type of a package file.

The connectivity manager 2548 may manage, for example, wireless connection such as Wi-Fi connection or BT connection, and the like. The notification manager 2549 may display or notify events, such as an arrival message, an appointment, and proximity notification, by a method which is not disturbed to the user. The location manager 2550 may manage location information of the electronic device. The graphic manager 2551 may manage a graphic effect to be provided to the user or a user interface (UI) related to the graphic effect. The security manager 2552 may provide all security functions necessary for system security or user authentication, and the like. According to an embodiment of the present disclosure, when the electronic device (e.g., an electronic device 2301 of FIG. 23) has a phone function, the middleware 2530 may further include a telephony manager (not shown) for managing a voice or video communication function of the electronic device.

The middleware 2530 may include a middleware module which configures combinations of various functions of the above-described components. The middleware 2530 may provide a module which specializes according to kinds of OSs to provide a differentiated function. Also, the middleware 2530 may dynamically delete some of old components or may add new components.

The API 2560 (e.g., an API 2345 of FIG. 23) may be, for example, a set of API programming functions, and may be provided with different components according to OSs. For example, in case of Android or iOS, one API set may be provided according to platforms. In case of Tizen, two or more API sets may be provided according to platforms.

The application 2570 (e.g., an application program 2347 of FIG. 23) may include one or more of, for example, a home application 2571, a dialer application 2572, a short message service/multimedia message service (SMS/MMS) application 2573, an instant message (IM) application 2574, a browser application 2575, a camera application 2576, an alarm application 2577, a contact application 2578, a voice dial application 2579, an e-mail application 2580, a calendar application 2581, a media player application 2582, an album application 2583, a clock application 2584, a health care application (e.g., an application for measuring quantity of exercise or blood sugar, and the like), or an environment information application (e.g., an application for providing atmospheric pressure information, humidity information, or temperature information, and the like), and the like.

According to an embodiment of the present disclosure, the application 1070 may include an application (hereinafter, for better understanding and ease of description, referred to as “information exchange application”) for exchanging information between the electronic device (e.g., the electronic device 2301) and an external electronic device (e.g., the first and second external electronic devices 2302 and 2304). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first and second external electronic devices 2302 and 2304). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the first and second external electronic devices 2302 and 2304) which communicates with the electronic device, an application which operates in the external electronic device, or a service (e.g., a call service or a message service) provided from the external electronic device.

According to an embodiment of the present disclosure, the application 1070 may include an application (e.g., the health card application of a mobile medical device) which is preset according to attributes of the external electronic device (e.g., the first and second external electronic devices 2302 and 2304). According to an embodiment of the present disclosure, the application 2570 may include an application received from the external electronic device (e.g., the server 2306 or the first and second external electronic devices 2302 and 2304). According to an embodiment of the present disclosure, the application 2570 may include a preloaded application or a third party application which may be downloaded from a server. Names of the components of the program module 2510 according to various embodiments of the present disclosure may differ according to kinds of OSs.

According to various embodiments of the present disclosure, at least part of the program module 2510 may be implemented with software, firmware, hardware, or at least two or more combinations thereof. At least part of the program module 2510 may be implemented (e.g., executed) by, for example, a processor (e.g., a processor 2320 of FIG. 23). At least part of the program module 2510 may include, for example, a module, a program, a routine, sets of instructions, or a process, and the like for performing one or more functions.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

According to various embodiments of the present disclosure, at least part of a device (e.g., modules or the functions) or a method (e.g., operations) may be implemented with, for example, instructions stored in computer-readable storage media which have a program module. When the instructions are executed by a processor (e.g., a processor 2320 of FIG. 23), one or more processors may perform functions corresponding to the instructions. The computer-readable storage media may be, for example, a memory 2330 of FIG. 23.

The computer-readable storage media may include a hard disc, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a ROM, a random access memory (RAM), or a flash memory, and the like), and the like. Also, the program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

According to various embodiments of the present disclosure, the electronic device may reduce a display burn-in phenomenon on any platform without recognition of the user for a change of a display position by changing the display position of display data output on a screen area of a specific or larger size upon occurrence of a specific event.

According to various embodiments of the present disclosure, the electronic device may reduce a degree to which the user recognizes a change of a display position by performing correction processing based on the change of the display position of display data.

According to various embodiments of the present disclosure, the electronic device may reduce a display burn-in phenomenon by changing display data output on a specified screen area if at least part of a screen is not changed during a specific time.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device, comprising:
a display;
a memory configured to store display data output on the display; and
a processor configured to be operatively coupled with the display and the memory,
wherein the processor is configured to:
change a position of the display data outputted on an active screen area if a screen output state change event for changing an output state of the active screen area of a designated size or more occurs; and
output the display data on the display based on the changed display position.

2. The electronic device of claim 1, wherein the processor is configured to:
change the position of the display data outputted on the active screen area, if an event for changing the display from a turn-off state to a turn-on state occurs, if an event for rotating a screen of the display occurs, or if an event for outputting display data different from display data previously outputted on the active screen area occurs; and
output the display data on the display based on the changed display position.

3. The electronic device of claim 1, wherein the processor is configured to:
output an additional display data on a display blank area induced by the change of the display position of the display data,
wherein the additional display data is previously outputted on an area corresponding to the display blank area of the active screen area before changing the display position of the display data, or outputted on an area adjacent to the display blank region.

4. The electronic device of claim 1, wherein the processor is configured to:
control the display not to output the display data on an area that is symmetrical on the display position with respect to a display blank area induced by the change of the display position of the display data.

5. The electronic device of claim 1, wherein the processor is configured to correct a touch coordinate of a touch panel, included in the electronic device or an external electronic device connected with the electronic device through wired and wireless communication, based on the changed display position of the display data.

6. The electronic device of claim 1, wherein the processor is configured to monitor a change state of the active screen area and to change the display data if a degree to which display data outputted on the active screen area is changed during a designated time is less than a designated value.

7. The electronic device of claim 6, wherein the processor is configured to logically operate previously outputted display data and subsequently outputted display data for each bit and to determine the degree, to which the display data is changed, based on the logically operated result.

8. The electronic device of claim 6, wherein the processor is configured to change the display data by at least one of:
changing color information of the display data,
blurring the display data, and
changing luminance information of the display data.

9. The electronic device of claim 8, wherein the processor is configured to change the display data by at least one of:
reducing the color information of the display data at a rate on a stage-by-stage basis at intervals of a time;
increasing a blurring level of the display data at a rate on a stage-by-stage basis at intervals of a time; and
reducing the luminance information of the display data at a rate on a stage-by-stage basis at intervals of a time.

10. The electronic device of claim 6, wherein the processor is configured to restore the display data if a touch input occurs or a mouse cursor is located on the active screen area.

11. A method for processing display data in an electronic device, the method comprising:
changing a position of the display data outputted on an active screen area if a screen output state change event for changing an output state of the active screen area of a designated size or more occurs; and
outputting the display data on the display based on the changed display position.

12. The method of claim 11, wherein the changing of the display position of the display data comprises:
changing the display position of the display data outputted on the active screen area, if an event for changing the display from a turn-off state to a turn-on state occurs, if an event for rotating a screen of the display occurs, or if an event for outputting display data different from display data previously outputted on the active screen area occurs.

13. The method of claim 11, further comprising:
outputting an additional display data on a display blank area induced by the change of the display position of the display data,
wherein the additional display data is previously outputted on an area corresponding to the display blank area of the active screen area before changing the display position of the display data, or outputted on an area adjacent to the display blank area.

14. The method of claim 11, further comprising:
controlling not to output the display data on an area that is symmetrical on the display position with respect to a display blank area induced by the change of the display position of the display data.

15. The method of claim 11, further comprising:
correcting a touch coordinate of a touch panel, included in the electronic device or an external electronic device connected with the electronic device through wired and wireless communication, based on the changed display position of the display data.

16. The method of claim 11, further comprising:
monitoring a change state of the active screen area;
determining a degree to which display data outputted on the active screen area is changed during a designated time; and
changing the display data if the degree to which the display data is changed is less than a designated value.

17. The method of claim 16, wherein the determining of the degree to which the display data is changed comprises:
logically operating previously outputted display data and subsequently outputted display data for each bit; and
determining the degree, to which the display data is changed, based on the logically operated result.

18. The method of claim 16, wherein the changing of the display data comprises:
at least one of changing color information of the display data, blurring the display data, and changing luminance information of the display data.

19. The method of claim 18, wherein the changing of the display data comprises:
at least one of reducing the color information of the display data at a rate on a stage-by-stage basis at intervals of a time, increasing a blurring level of the display data at a rate on a stage-by-stage basis at intervals of a time, and reducing the luminance information of the display data at a rate on a stage-by-stage basis at intervals of a time.

20. The method of claim 16, further comprising:
restoring the display data, if a touch input occurs or a mouse cursor is located on the active screen area.
